(19) United States
(12) Patent Application Publication
(10) Pub. No.: US 2026/0350749 A1
(43) Pub. Date: Nov. 5, 2026

(54) GENERATIVE COMPOSITION RECOMMENDATIONS USING A MULTI-MODAL LARGE LANGUAGE MODEL

(71) Applicant: Adobe Inc., San Jose, CA (US)

(72) Inventors: Zhe Lin, Fremont, CA (US); Yuqian Zhou, Seattle, WA (US); Yizhou Wang, Boston, MA (US); Sohrab Amirghodsi, Seattle, WA (US); Qing Liu, Santa Clara, CA (US); Mang Tik Chiu, Champaign, IL (US); Lingzhi Zhang, Philadelphia, PA (US); Elya Shechtman, Seattle, WA (US); Connelly Barnes, Seattle, WA (US)

(21) Appl. No.: 19/180,626

(22) Filed: Apr. 16, 2025

(51) Int. Cl. G06T 5/50; G06T 7/50; G06V 10/25; G06V 10/77

(52) U.S. Cl. CPC G06T 5/50; G06T 7/50; G06V 10/25; G06V 10/7715; G06T 2207/20221

(57) ABSTRACT

The present disclosure relates to systems, methods, and non-transitory computer-readable media that generates a predicted image composition that describes a composite image. Furthermore, the disclosed systems receives an image composition prompt that includes a background image or a foreground image and a text prompt. Moreover, the disclosed systems generate a predicted image composition based on the image composition prompt by using a multi-modal large language model. Further, the disclosed systems generate a composite image based on the background image or the foreground image modified according to the predicted image composition.

### BACKGROUND

Recent years have seen significant advancement in hardware and software platforms for compositing an object into an image. Indeed, systems provide a variety of ways to harmonize pixel values of objects being inserted into an image. For instance, systems leverage a variety of generative models for performing image editing tasks, such as compositing multiple images together. Despite the advances in compositing an object into an image, systems suffer from a number of deficiencies with regard to accuracy, efficiency, operational flexibility.

### SUMMARY

One or more embodiments described herein provide benefits and/or solve one or more problems in the art with systems, methods, and non-transitory computer-readable media that leverage advanced reasoning capabilities of multi-modal large language models to generate predicted image compositions. In particular, the disclosed systems utilize multi-modal large language models to generate suggestions for suitable image concepts (e.g., recommended foreground objects to insert into a background or a recommended background image for a foreground object) and compatible composition locations (e.g., a location and depth to insert a foreground object into a background image). In one or more embodiments, the disclosed systems use a data pipeline that automatically generates diverse, high-quality, large-scale training data and uses the training dataset to fine-tune the multi-modal large language model to achieve robust content recommendation and precise object placement. In particular, the disclosed systems provide flexible input options (e.g., text inputs, image inputs, and/or user-defined placement control) to guide an image composition process for generating composite images.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a generative-composition recommendation system operates in accordance with one or more implementations;

FIG. 2 illustrates an overview of the generative-composition recommendation system generating a predicted image composition that describes a composite image in accordance with one or more implementations;

FIG. 3 illustrates an example diagram of the generative-composition recommendation system generating a predicted foreground for a provided background image in accordance with one or more implementations;

FIG. 4 illustrates an example diagram of the generative-composition recommendation system generating a predicted background for a provided foreground image in accordance with one or more implementations;

FIG. 5 illustrates an example diagram of the generative-composition recommendation system generating a predicted position of a foreground object in a provided background image in accordance with one or more implementations;

FIG. 6 illustrates an example diagram of the generative-composition recommendation system utilizing separate projectors for different image types in accordance with one or more implementations;

FIG. 7 illustrates an example diagram of the generative-composition recommendation system utilizing a generative rendering model to generate a composite image in accordance with one or more implementations;

FIGS. 8A-8C illustrates an example diagram of the generative-composition recommendation system predicting a cutout occlusion mask using a depth map in accordance with one or more implementations;

FIG. 9 illustrates an example diagram of the generative-composition recommendation system using a data preprocessing pipeline to filter training data for fine-tuning a multi-modal large language model in accordance with one or more implementations;

FIG. 10 illustrates an example diagram of the generative-composition recommendation system generating training data with ground-truth composition information in accordance with one or more implementations;

FIG. 11 illustrates an example diagram of the generative-composition recommendation system generating training data bundles in accordance with one or more implementations;

FIG. 12 illustrates an example diagram of the generative-composition recommendation system modifying parameters of the multi-modal large language model in accordance with one or more implementations;

FIG. 13 illustrates a schematic diagram of the generative-composition recommendation system in accordance with one or more implementations;

FIG. 14 illustrates a flowchart of a series of acts for generating a composite image in accordance with one or more implementations;

FIG. 15 illustrates a block diagram of an exemplary computing device in accordance with one or more implementations.

### DETAILED DESCRIPTION

One or more embodiments described herein includes a generative-composition recommendation system that leverages an advanced multi-modal large language model to perform conditional content recommendation and object placement recommendation. In particular, image composition is an important aspect of image editing workflows, and image designers are typically faced with challenges involving synthesizing selected background/foreground elements and adapting them into cohesive combinations. In one or more embodiments, the generative-composition recommendation system utilizes a multi-modal large language model (e.g., fine-tuned for image composition tasks) to generate prompts that yield elements compatible with existing images. In particular, the generative-composition recommendation system renders spatially, and visually harmonious compositions based on generated prompts (e.g., predicted image compositions). In other words, the generative-composition recommendation system generates a predicted image composition with intelligent content recommendations and object placement suggestions, making the image composition process more efficient and intuitive.

In one or more embodiments, the generative-composition recommendation system generates prompts (e.g., predicted image compositions) for a generative model for precise and aesthetically coherent foreground elements for a given background image (e.g., a background image part of an image composition prompt provided by a user of a computing device). Conversely, in some embodiments, the generative-composition recommendation system also generates prompts (e.g., predicted image compositions) for a generative model that suggest plausible backgrounds for a provided foreground image (e.g., foreground image part of an image composition prompt provided by a user of a computing device). Additionally, in some embodiments, the generative-composition recommendation system generates prompts for generative models that suggest object placement (e.g., depth and location). In particular, the generative-composition recommendation system generates object placement prompts that offer robust, contextually appropriate, and user-controllable suggestions for positioning, scale, and depth of foreground elements within a background image.

In one or more embodiments, the generative-composition recommendation system fine-tunes the multi-modal large language model on curated datasets to achieve enhanced effectiveness, robustness, and control. In particular, the fine-tuned multi-modal large language model allows the generative-composition recommendation system to provide detailed, contextually appropriate recommendations that adhere to fundamental compositional logic. In some embodiments, the generative-composition recommendation system uses a scalable and effective data generation pipeline that integrates image processing steps such as filtering, segmentation, captioning, and object removal. In particular, the generative-composition recommendation system uses the data generation pipeline to produce high-quality, dense data, enhancing both learning, efficiency, and generalization of the multi-modal large language model.

In one or more embodiments, the generative-composition recommendation system utilizes a multi-modal large language model architecture with independent projectors. In particular, the generative-composition recommendation system uses an independent projector for different image types (e.g., background images, foreground images, and depth maps). In some embodiments, the generative-composition recommendation system uses separate projectors to effectively extract and fuse foreground images, background images, and text, achieving superior integration relative to existing baselines.

As mentioned above, the generative-composition recommendation system generates prompts for generative models that suggest object placement (e.g., depth and location). In one or more embodiments, the generative-composition recommendation system uses the multi-modal large language model to suggest placements for flexible foreground modalities (e.g., image or text). In particular, the generative-composition recommendation system fully considers the provided image data (e.g., data provided as part of an image composition prompt from a user) to determine how to insert an object within a background that is in an appropriate location and at an appropriate depth. For example, the generative-composition recommendation system determines an appropriate depth of an object by determining cut-off occlusions of the object inserted into a background image. Additionally, in some embodiments, the generative-composition recommendation system provides multiple-round interaction functionality such that a user of a computing device iteratively modifies a composite image.

As mentioned above, existing systems suffer from a number of issues relating to computational accuracy, efficiency, and operational flexibility. For example, some existing systems use generative image technologies that generate prompts that yield image elements that are incompatible with existing images. In particular, existing systems often fail to account for generative content that conforms with an existing image provided as part of an image generation request. As such, many existing systems suffer from generating inaccurate composite images that seem unnatural and are not aesthetically pleasing. In other words, existing systems often generate composite images that fail to accurately harmonize pixels and fail to suggest suitable concepts/positions of objects in an image.

Moreover, due to the inaccuracies of existing systems, existing systems further suffer from computational inefficiencies. For example, some existing systems further require users of computing devices to perform excessive modifications and consume extra time to attempt to yield a desirable product. In particular, such existing systems often recommend content to insert into an image that does not fit within the context of the image, thus users are forced to prompt and re-prompt the system for additional recommendations.

In addition, existing systems also suffer from operational inflexibilities. For example, existing systems provide a variety of tools to attempt to provide object generation recommendations (e.g., that are often inaccurate, unnatural, and not aesthetically pleasing). However, to generate object generation recommendations, existing systems rely on background images with already defined missing areas in the image, which limits the flexibility in object type and placement within the image. In other words, existing systems are rigidly confined to performing object generation recommendation tasks for background images that are already labeled/annotated.

In one or more embodiments, the generative-composition recommendation system provides several improvements over existing systems in relation to accuracy, efficiency, and operational flexibility. As mentioned above, existing systems generate image elements that are incompatible with images provided by a user of a computing device. In contrast to existing systems, the generative-composition recommendation system fully considers an image composition prompt (e.g., with a background image, a foreground image and/or a text prompt) by generating a predicted image composition based on the image composition prompt.

In particular, the generative-composition recommendation system utilizes a multi-modal large language model to perform advanced reasoning tasks of determining how to put together a composite image from the image composition prompt. In other words, the generative-composition recommendation system suggests suitable concepts/positions of objects in an image. Accordingly, the generative-composition recommendation system generates accurate composite images that are natural and aesthetically pleasing.

As also mentioned above, existing systems inefficiently generate suggestions to compose unnatural and unaesthetically pleasing elements within an image. In contrast, the generative-composition recommendation system generates a composite image according to a predicted image composition (e.g., using a multi-modal large language model), which reduces the time and resources required to arrive at a desirable composite image. In other words, the generative-composition recommendation system reduces the number of prompts and re-prompts for image composition tasks. Thus, due to the accuracy improvements of the generative-composition recommendation system in generating composite images, the generative-composition recommendation system further improves upon computational efficiencies by saving time and resources.

Relatedly, the generative-composition recommendation system improves upon operational flexibility. Rather than relying on background images with already defined missing areas, the generative-composition recommendation system allows for a user of a computing device to flexibly submit a wide range of image composition prompts. In particular, the generative-composition recommendation system receives image composition prompts made up of one or more background images, foreground images, user controls, or text prompts, and generates a predicted image composition from the image composition prompt. As such, the generative-composition recommendation system flexibly creates composite images from a variety of different inputs.

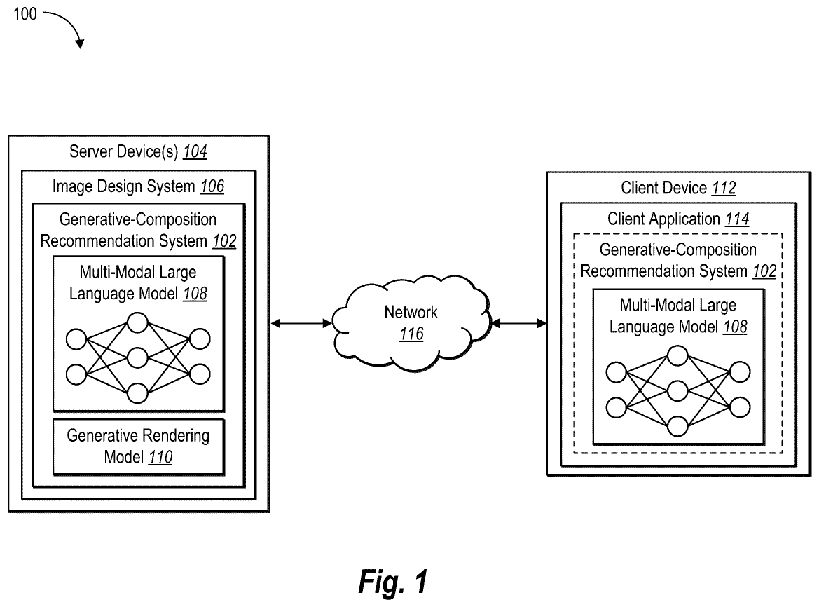

Additional details regarding the generative-composition recommendation system will now be provided with reference to the figures. For example, FIG. 1 illustrates a schematic diagram of an exemplary system environment 100 in which a generative-composition recommendation system 102 operates. As illustrated in FIG. 1, the system environment 100 includes server device(s) 104, an image design system 106, a network 116, and a client device 112. Additionally, FIG. 1 illustrates that the image design system 106 includes the generative-composition recommendation system 102, which includes a multi-modal large language model 108 and a generative rendering model 110. Moreover, the client device 112 includes a client application 114 (e.g., a client side design/editing application).

Although the system environment 100 of FIG. 1 is depicted as having a particular number of components, the system environment 100 is capable of having a different number of additional or alternative components (e.g., a different number of server devices, client devices, or other components in communication with the generative-composition recommendation system 102 via the network 116). Similarly, although FIG. 1 illustrates a particular arrangement of the server device(s) 104, the network 116, and the client device 112, various additional arrangements are possible.

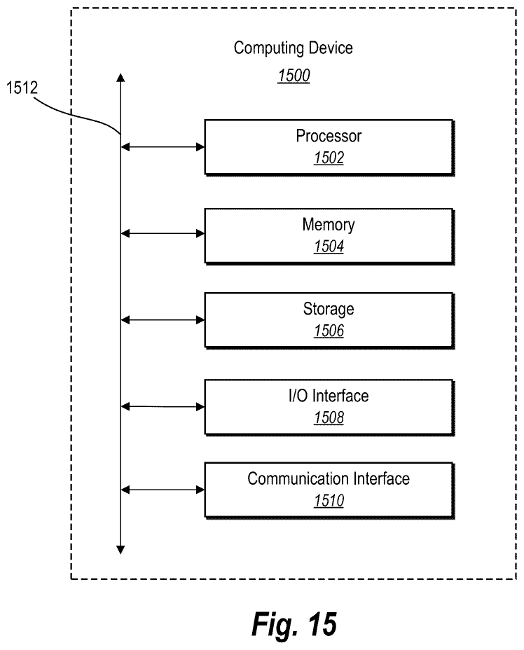

The server device(s) 104 and the client device 112 are communicatively coupled with each other either directly or indirectly (e.g., through the network 116 discussed in greater detail below in relation to FIG. 15). Moreover, the server device(s) 104 and the client device 112 include one or more of a variety of computing devices (including one or more computing devices as discussed in greater detail in relation to FIG. 15).

As mentioned above, the system environment 100 includes the server device(s) 104. In one or more embodiments, the server device(s) 104 process input for generating composite images (e.g., by employing one or more models such as the multi-modal large language model 108). In one or more embodiments, the server device(s) 104 comprise a data server. In some implementations, the server device(s) 104 comprise a communication server or a web-hosting server.

In some embodiments, the client device 112 is associated with the one or more user accounts that submit image composition prompts to generate composite digital images. In one or more embodiments, the client device 112 includes smartphones, tablets, desktop computers, laptop computers, head-mounted-display devices, or other electronic devices. The client device 112 includes one or more software applications (e.g., the client application 114) for generating or modifying composite digital images in accordance with the image design system 106. In one or more embodiments, the client application 114 includes a software application hosted on the server device(s) 104 accessible by the client device 112 through another application, such as a web browser.

To provide an example implementation, in some embodiments, the image design system 106 on the server device(s) 104 supports the client application 114 on the client device 112. For instance, in some cases, the generative-composition recommendation system 102 on the server device(s) 104 trains the multi-modal large language model 108. In response, the generative-composition recommendation system 102, via the server device(s) 104, provides the trained multi-modal large language model 108 to the client device 112. In other words, the client device 112 obtains (e.g., downloads) the multi-modal large language model 108 from the server device(s) 104 that is already trained/optimized. Once downloaded, the multi-modal large language model 108 on the client device 112 is able to perform image composition tasks (e.g., generating predicted image compositions) independent from the server device(s) 104. In one or more alternative implementations, the generative-composition recommendation system 102 generates or learns parameters for the multi-modal large language model 108 in whole or in part on the client device 112.

In alternative implementations, the image design system 106 includes a web hosting application that allows the client device 112 to interact with content and services hosted on the server device(s) 104. To illustrate, in one or more implementations, the client device 112 accesses a software application supported by the server device(s) 104. In response, the image design system 106 on the server device(s) 104 provides tools for performing image composition tasks, such as generating predicted image compositions. In other words, the client device 112 does not have to download the generative-composition recommendation system 102 or the multi-modal large language model 108 while still being able to access/utilize the trained/optimized tools provided by the image design system 106 via a web hosting application.

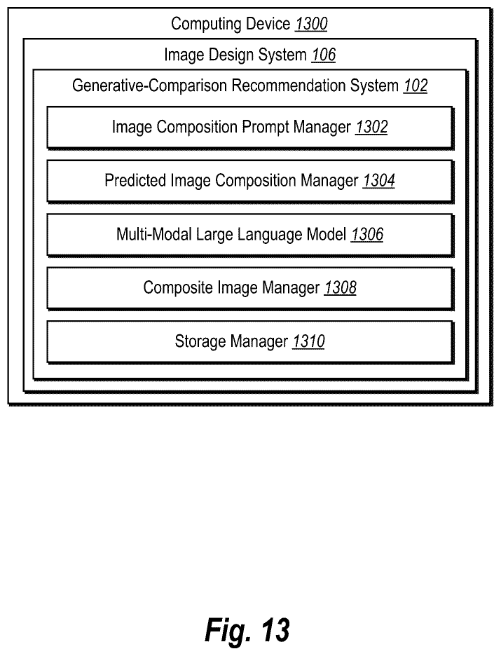

In some embodiments, the generative-composition recommendation system 102 is implemented in whole, or in part, by the individual elements of the system environment 100. For instance, although FIG. 1 illustrates the generative-composition recommendation system 102 implemented or hosted on the server device(s) 104, different components of the generative-composition recommendation system 102 are able to be implemented by a variety of devices within the system environment 100. For example, one or more (or all) components of the generative-composition recommendation system 102 are implemented by a different computing device or a separate server from the server device(s) 104. Indeed, as shown in FIG. 1, the client device 112 includes the generative-composition recommendation system 102. Example components of the generative-composition recommendation system 102 will be described below with regard to FIG. 13.

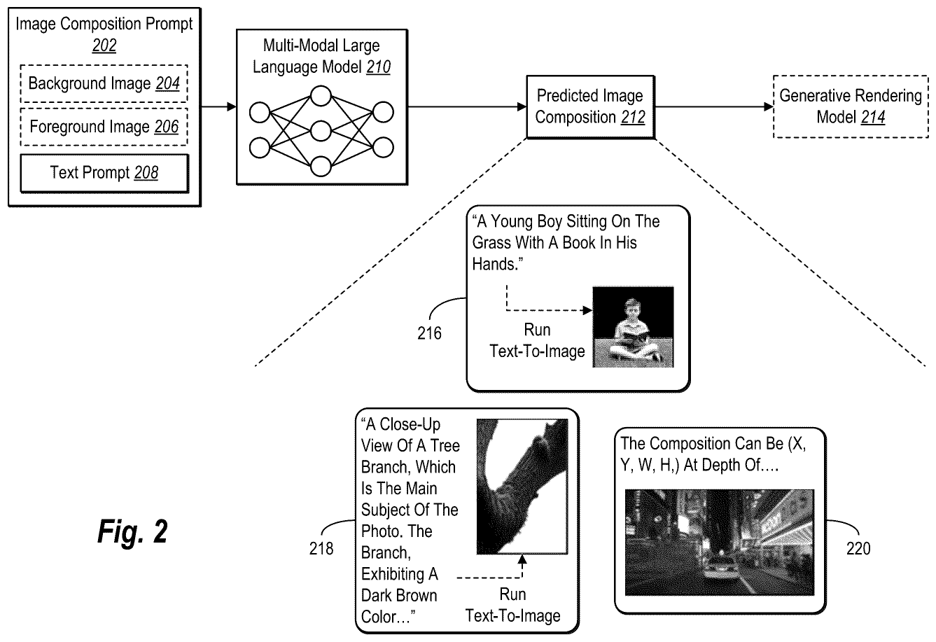

As mentioned above, in certain embodiments, the generative-composition recommendation system 102 generates a predicted image composition from an image composition prompt. FIG. 2 illustrates the generative-composition recommendation system 102 using a multi-modal large language model to generate a predicted image composition in accordance with one or more embodiments.

As shown in FIG. 2, the generative-composition recommendation system 102 accesses/receives an image composition prompt 202. In one or more embodiments, a prompt refers to a request, question, or instruction to elicit a specific response or action from a model. Specifically, the prompt includes a text or visual input to guide a model to generate a specific response. In some embodiments, the prompt includes an image composition prompt. In particular, the image composition prompt refers to instructions to a multi-modal large language model 210 to generate a prediction for how an image should be composed.

As shown in FIG. 2, in some embodiments, the image composition prompt 202 includes a background image 204 or a foreground image 206 and/or a text prompt 208 (e.g., that provides textual instructions of what a user desires to achieve). In some embodiments, the image composition prompt 202 only includes visual inputs, and in some embodiments, the image composition prompt only includes textual inputs.

Further, in some embodiments, the image composition prompt 202 includes user controls and additional textual inputs such as a description of one or more of the provided visual inputs. In other words, the generative-composition recommendation system 102 accesses/receives the image composition prompt 202 (e.g., that includes the foreground image 206, the background image 204, the text prompt 208, user inputs, and/or textual descriptions) and generates a prediction of how to compose a visual output based on the image composition prompt 202.

As mentioned, the image composition prompt 202 includes visual inputs (e.g., digital images with image elements). In one or more embodiments, a digital image includes various pictorial elements. In particular, the pictorial elements include pixel values that define the spatial and visual aspects of the digital image such as text and image objects. In some embodiments, the digital image refers to a rasterized image which includes a grid of pixels. In particular, the rasterized image includes a fixed resolution as determined by a number of pixels within the digital image. Further, in some embodiments, the digital image refers to a vector image made up of paths defined by points, lines, curves, and shapes. Specifically, the vector image is infinitely scalable without losing quality.

As mentioned above, in some embodiments, the generative-composition recommendation system 102 receives the image composition prompt 202 that includes the text prompt 208. In one or more embodiments, the text prompt 208 refers to a set of instructions that the generative-composition recommendation system 102 provides to the multi-modal large language model 210 to elicit a response from the multi-modal large language model. To illustrate, in some embodiments, the text prompt refers to a question such as “how should the foreground image be inserted into the background image?”

As shown in FIG. 2, the generative-composition recommendation system 102 provides the image composition prompt 202 to a machine learning model (e.g., the multi-modal large language model 210). In one or more embodiments, a machine learning model includes a computer algorithm or a collection of computer algorithms that is trained and/or tuned based on inputs to approximate unknown functions. For example, a machine learning model includes a computer algorithm with branches, weights, or parameters that changed based on training data to improve for a particular task. Thus, a machine learning model utilizes one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a large language model, or a multi-layer perceptron. In some embodiments, a neural network includes a combination of neural networks or neural network components.

In one or more embodiments, a large language model includes or refers to one or more neural networks capable of processing natural language text to generate outputs that range from predictive outputs, analyses, or combinations of data within stored content items. In particular, a large language model includes parameters trained (e.g., via deep learning) on large amounts of data to learn patterns and rules of language for summarizing and/or generating digital content. Examples of large language models include Adobe Assistant AI, and GPT-based models.

In some embodiments, the large language model contains an input layer, a plurality of hidden layers, and an output layer (e.g., that outputs tokens based on hidden states). In some embodiments, the large language model is modeled after a recurrent neural network (RNN), a long short-term memory network (LSTM), a gated recurrent unit network (GRU), a transformer model, or a bidirectional encoder representations from transformers.

In one or more embodiments, the generative-composition recommendation system 102 utilizes the multi-modal large language model 210 to generate the predicted image composition 212 responsive to a prompt (e.g., the image composition prompt 202). Specifically, the multi-modal large language model 210 includes an artificial intelligence model to process and understand inputs from different data modalities (e.g., text and visual inputs).

In some embodiments, the multi-modal large language model 210 is a language-based transformer model that the generative-composition recommendation system 102 utilizes to process tokens. In other words, the generative-composition recommendation system 102 unifies (e.g., fuses information) a latent space for a diverse set of modes (e.g., text and image) to further determine the predicted image composition 212. In some embodiments, the multi-modal large language model 210 includes a text encoder and an image encoder to encode different modalities from the image composition prompt 202 and further transforms a feature map (e.g., of an image) into image tokens (e.g., utilizing a projector).

As shown in FIG. 2, the generative-composition recommendation system 102 utilizes the multi-modal large language model 210 to generate the predicted image composition 212. In one or more embodiments, the predicted image composition 212 refers to a text description of a composite image. In particular, the predicted image composition 212 describes 1) an appropriate background image for a foreground object, 2) an appropriate foreground object for a background image, and/or 3) how to place a foreground object in a background image (e.g., at an appropriate depth and location).

In some embodiments, the predicted image composition 212 suggests a type of image (background image or foreground image) based on the image composition prompt 202 and further provides a position/depth of how to place the suggested type of image. To illustrate, if the image composition prompt 202 includes a background image of a tomato farm and a text prompt of “what could be inserted into this background image?” the generative-composition recommendation system 102 generates a predicted image composition of “a woman in a plaid shirt and jeans is picking tomatoes.”

As shown in FIG. 2, in some embodiments, the predicted image composition 212 is a suggested foreground object 216. In particular, the suggested foreground object 216 of the predicted image composition 212 is a text description of “a young boy sitting on the grass with a book in his hands.” Moreover, FIG. 2 further shows that the generative-composition recommendation system 102 utilizes “text-to-image” to synthesize the suggested foreground object 216. In other words, in some embodiments, the generative-composition recommendation system 102 utilizes a generative rendering model 214 (e.g., a text-to-image generation model) to generate the suggested foreground object 216.

As shown in FIG. 2, in some embodiments, the predicted image composition 212 is a suggested background image 218 for a foreground object. In particular, the suggested background image 218 of the predicted image composition 212 is a text description of “a close-up view of a tree branch, which is the main subject of the photo. The branch, exhibiting a dark brown color . . . ” Moreover, FIG. 2 further shows that the generative-composition recommendation system 102 utilizes “text-to-image” to synthesize the suggested background image 218. In other words, in some embodiments, the generative-composition recommendation system 102 utilizes the generative rendering model 214 to generate the suggested background image 218.

As shown in FIG. 2, in some embodiments, the predicted image composition 212 is a suggested position 220 of an object. In particular, the suggested position 220 of the object of the predicted image composition 212 is a text description of “the composition can be (x, y, w, h,) a t depth of . . . .” Moreover, in some embodiments, the generative-composition recommendation system 102 utilizes the generative rendering model 214 to generate a foreground object in a background image at the suggested position 220.

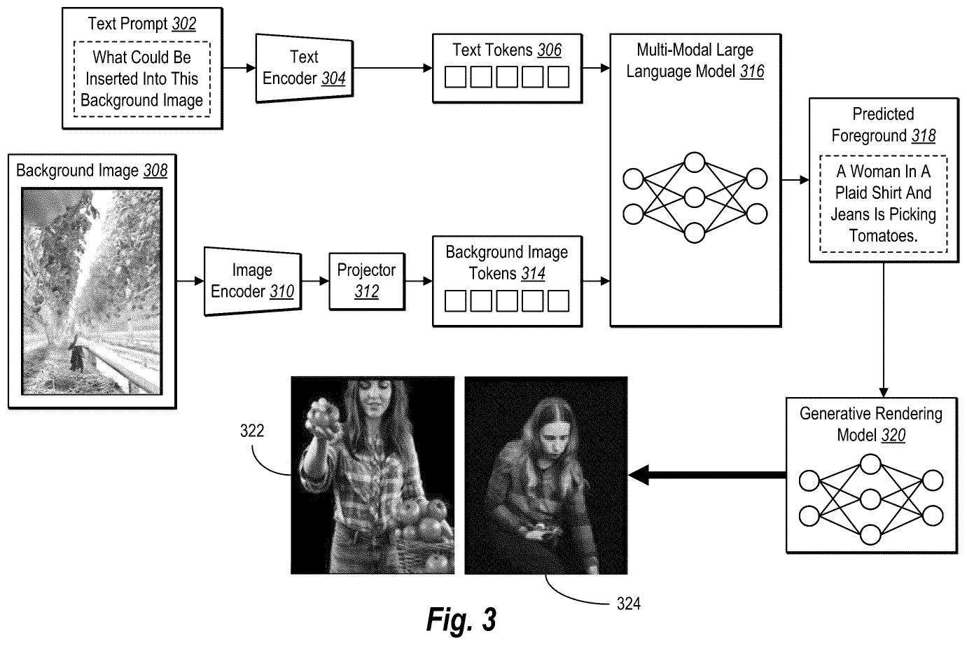

As mentioned above, in certain embodiments, the generative-composition recommendation system 102 generates a predicted foreground object. For example, FIG. 3 shows the generative-composition recommendation system 102 generating a predicted image composition of a predicted foreground based on a background image and a text prompt in accordance with one or more embodiments.

FIG. 3 shows the generative-composition recommendation system 102 receiving/accessing a text prompt 302 and a background image 308. As mentioned above, in some embodiments, the image composition prompt includes a background image. In one or more embodiments, the background image 308 refers to an image scene that is furthest from a viewer or focal point. In particular, the background image 308 establishes the context, texture, or atmosphere. To illustrate, the background image 308 refers to a scene such as a farm, a lake, a mountain, a house, under the sea, and a city landscape.

Moreover, FIG. 3 shows the generative-composition recommendation system 102 utilizing an image encoder 310 to extract raw data from the background image 308 and generate a feature map. In one or more embodiments, the image encoder 310 is a neural network (or one or more layers of a neural network) that extract features relating to digital images. In some cases, an image encoder refers to a neural network that both extracts and encodes features from a digital image.

In some embodiments, the image encoder 310 includes a particular number of layers including one or more fully connected and/or partially connected layers of neurons that extract image patches from the background image 308 and encode localized features of the background image 308 to generate a feature map. To illustrate, in one or more embodiments, the generative-composition recommendation system 102 generates a feature map/image embedding (e.g., extracts raw data) that represents a complete frame of the background image 308.

In one or more embodiments, the generative-composition recommendation system 102 utilizes the image encoder 310 to generate a feature map. In particular, a feature map refers to a representation of features extracted from image data (e.g., the background image 308). For example, the feature map represents a transformation of an input image that highlights specific patterns, structures, or features (e.g., edges, height, width, depth, etc.). In some embodiments, the generative-composition recommendation system 102 utilizes the image encoder 310 to generate image embeddings. In some embodiments, the image embeddings include a numerical representation (e.g., a vector) of a digital image. For instance, the image embeddings capture features and properties of the digital image (e.g., the background image 308). To illustrate, the image embeddings include semantic information, such as the presence of objects, shapes, and spatial relationships.

As further shown in FIG. 3, the generative-composition recommendation system 102 utilizes a projector 312 (e.g., a background projector) to generate background image tokens 314 from the feature map/image embeddings generated by using the image encoder 310. In one or more embodiments, the projector 312 refers to a component or network layer that transforms data from one modality into a shared embedding space. In particular, the projector 312 transforms data from the image modality into a shared embedding space (e.g., to be compatible with text tokens).

In some embodiments, the generative-composition recommendation system 102 utilizes a distinct projector for each type of image. In particular, the generative-composition recommendation system 102 utilizes a background projector for background images, a foreground projector for foreground images, and a depth projector for a depth map of a background image. In some embodiments, the generative-composition recommendation system 102 fine-tunes/trains each projector of a multi-modal large language model 316 to accurately transform data into the shared embedding space.

Thus, the generative-composition recommendation system 102 utilizes the image encoder 310 to extract raw data from an image (e.g., image embeddings/a feature map) and then further utilizes the projector 312 to transform the raw data into a specific type of image token (e.g., background image tokens, foreground image tokens, and depth tokens). As shown, the generative-composition recommendation system 102 generates the background image tokens 314 from the background image 308 by projecting (via the projector 312) the data of the background image 308 into a unified embedding space.

As already mentioned, the generative-composition recommendation system 102 receives/accesses the text prompt 302 and utilizes a text encoder 304 to process the text prompt 302. In one or more embodiments, the text encoder 304 includes a component of a neural network to transform textual data (e.g., the text prompt) into a numerical representation. For instance, the generative-composition recommendation system 102 utilizes the text encoder 304 to transform the text prompt 302 into a text encoding (e.g., text tokens 306).

Further, the generative-composition recommendation system 102 utilizes the text encoder 304 in a variety of ways. For instance, the generative-composition recommendation system 102 utilizes the text encoder 304 to i) determine the frequency of individual words in the text prompt 302 (e.g., each word becomes a feature vector), ii) determine a weight for each word within the text prompt 302 to generate a text vector that captures the importance of words within a text prompt, iii) generate low-dimensional text vectors in a continuous vector space that represents words within the text prompt 302, and/or iv) generate contextualized text vectors by determining semantic relationships between words within the text prompt.

In one or more embodiments, the generative-composition recommendation system 102 generates the text tokens 306 from the text prompt 302. In particular, the generative-composition recommendation system 102 utilizes the text encoder 304 to generate a representation of the text prompt 302 for a machine learning task. For example, the generative-composition recommendation system 102 generates a representation such as the text tokens 306, where text tokens 306 refer to the smallest units into which text is broken down for processing by a machine learning model. In some embodiments, a single text token refers to a word, a sub-word, or a character (e.g., “the,” “on,” “cat,” “t,” “showcasing,” “show,” “casing,” etc.). Furthermore, the generative-composition recommendation system 102 generates tokens representing special meaning or purposes such as the beginning or an end of a sentence. Thus, the generative-composition recommendation system 102 generates tokens representing the text prompt 302 of “what could be inserted into this background image?”

As shown in FIG. 3, the generative-composition recommendation system 102 utilizes the multi-modal large language model 316 to process the text tokens 306 and the background image tokens 314 and generate a predicted image composition. In particular, FIG. 3 shows the generative-composition recommendation system 102 generating a predicted foreground 318 for the background image 308 (e.g., the tomato farm). To illustrate, the predicted foreground 318 reads “a woman in a plaid shirt and jeans is picking tomatoes.”

In some embodiments, the predicted foreground 318 is a text description of a suggested foreground image/object to insert into the background image 308. Text tokens were mentioned above. In some embodiments, the generative-composition recommendation system 102 utilizes an additional text encoder to further generate text tokens of the predicted image composition (e.g., the predicted foreground 318). In particular, the text tokens of the predicted image composition encode the predicted image composition for a downstream machine learning task.

In some embodiments, the generative-composition recommendation system 102 performs a downstream machine learning task of generating an image representing the predicted foreground 318. In particular, the generative-composition recommendation system 102 utilizes a generative rendering model 320 to synthesize/generate a first foreground image 322 and a second foreground image 324. For example, the first foreground image 322 depicts a lady picking tomatoes and putting the tomatoes in a basket and the second foreground image 324 shows a lady holding tomatoes in her shirt. Although not shown in FIG. 3, in some embodiments, the generative-composition recommendation system 102 further utilizes generative models (e.g., the generative rendering model 320) to combine the first foreground image 322 with the background image 308 and/or the second foreground image 324 with the background image 308.

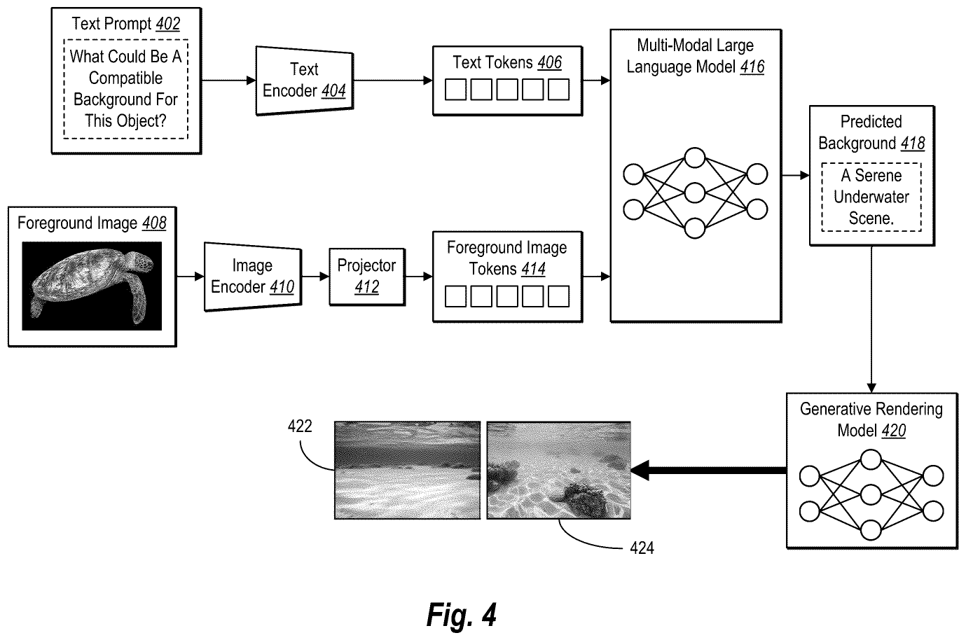

As mentioned above, in certain embodiments, the generative-composition recommendation system 102 generates a predicted background for a foreground image. For example, FIG. 4 shows the generative-composition recommendation system 102 utilizing a multi-modal large language model to generate a predicted background for a foreground image in accordance with one or more embodiments.

As shown in FIG. 4, the generative-composition recommendation system 102 receives/accesses a text prompt 402 and a foreground image 408. As mentioned above, in some embodiments, an image composition prompt includes a foreground image. In one or more embodiments, the foreground image 408 refers to an image scene that is closest to the viewer or focal point. In particular, the foreground image 408 refers to an object that is typically overlaid on top of a background scene.

To illustrate, the foreground image 408 (e.g., foreground object) depicts a person, place, text, or thing. In some embodiments, a foreground object includes a person, an item, a natural object (e.g., a tree or rock formation) or a structure depicted in the image. Moreover, in some embodiments, a foreground object includes text that depicts a word or a series of words.

As shown in FIG. 4, the generative-composition recommendation system 102 utilizes an image encoder 410 to extract raw data from the foreground image 408 and generate image embeddings/a feature map from the foreground image 408. Moreover, FIG. 4 shows the generative-composition recommendation system 102 utilizing a projector 412 to generate foreground image tokens 414. As mentioned above, the generative-composition recommendation system 102 utilizes a distinct projector for each image type. Thus, FIG. 4 illustrates the generative-composition recommendation system 102 utilizing a foreground projector to project the extracted image data from the foreground image 408 into a unified embedding space.

As also mentioned above, the generative-composition recommendation system 102 utilizes a text encoder 404 to process the text prompt 402. To illustrate, the text prompt 402 reads “what could be a compatible background for this object?” In particular, the generative-composition recommendation system 102 utilizes the text encoder 404 to generate text tokens 406.

Moreover, as shown in FIG. 4, the generative-composition recommendation system 102 utilizes a multi-modal large language model 416 to process the text tokens 406 and the foreground image tokens 414 to generate a predicted image composition. For example, FIG. 4 shows the predicted image composition as a predicted background 418 that reads “a serene underwater scene.” Additionally, the generative-composition recommendation system 102 utilizes a generative rendering model 420 to generate a first background image 422 and a second background image 424 that represents the predicted background 418 of “a serene underwater scene.”

Furthermore, although not shown in FIG. 4, in some embodiments, the generative-composition recommendation system 102 utilizes the multi-modal large language model 416 to synthesize the first background image 422 or the second background image 424 with the foreground image 408. In particular, in some embodiments, the generative-composition recommendation system 102 synthesizes a first combined image of the foreground image 408 with the first background image 422 and a second combined image of the foreground image 408 with the second background image 424. In some embodiments, the generative-composition recommendation system 102 provides an option for a user of a computing device to select either the first background image 422 or the second background image 424 to select from.

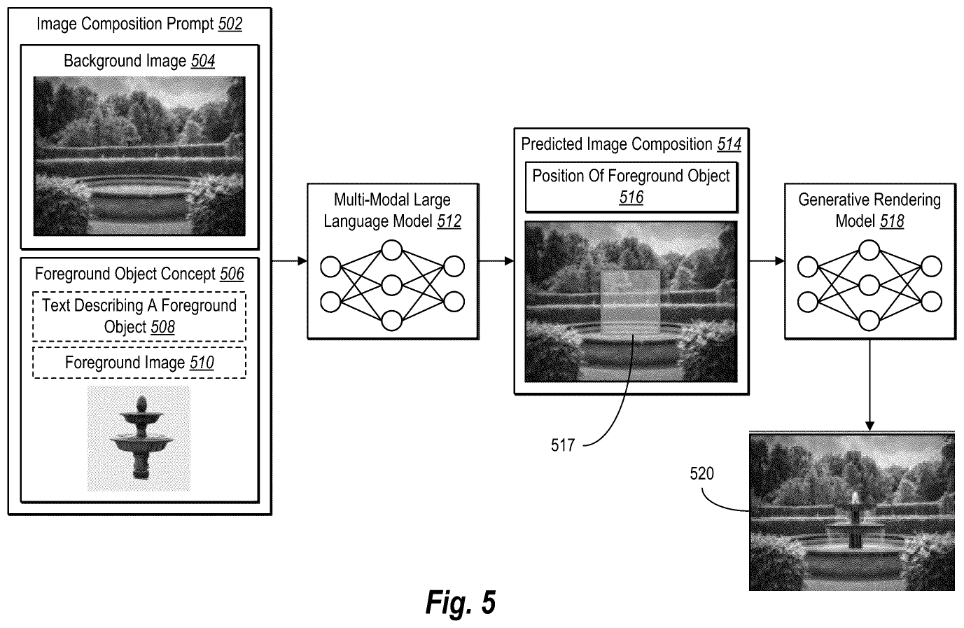

As mentioned above, the generative-composition recommendation system 102 generates foreground/background recommendations and in certain embodiments, further generates a predicted position (e.g., depth and location) of the recommendation. For example, FIG. 5 shows the generative-composition recommendation system 102 receiving/accessing an image composition prompt 502. In particular, FIG. 5 shows the image composition prompt 502 includes a background image 504 and a foreground object concept 506. FIG. 5 also shows that in some embodiments, the foreground object concept 506 includes text 508 describing a foreground object and/or a foreground image 510.

In one or more embodiments, the image composition prompt 502 further includes a foreground object concept 506. In particular, the foreground object concept 506 refers to an image of a foreground object or a textual description of a foreground object. To illustrate, the generative-composition recommendation system 102 receives the image composition prompt 502 with the background image 504 and the foreground object concept 506, and the generative-composition recommendation system 102 generates a predicted image composition 514 of the foreground object concept 506 in the background image 504.

As shown in FIG. 5, the generative-composition recommendation system 102 utilizes a multi-modal large language model 512 to generate the predicted image composition 514. In particular, FIG. 5 shows that the predicted image composition 514 includes a position 516 of a foreground object.

In some embodiments, the predicted image composition 514 includes a predicted position of how to insert a foreground object into the background image 504. To illustrate, the generative-composition recommendation system 102 utilizes the information from the image composition prompt (e.g., the background image 504, and/or a depth map of the background image 504) to determine appropriate and natural positions of a foreground object within the background image 504. In particular, the predicted position of the predicted image composition 514 includes “insert this foreground object on the left side of the background image where the composition is at (x, y, w, h) at a depth of Z.

In one or more embodiments, the prediction position of the predicted image composition 514 further includes a scene graph. In particular, a scene graph refers to a structural graph of nodes connected by edges, where the nodes and edges have attributes that describe characteristics of objects or relationships. In contrast to a depth map, a scene graph contains semantic and relational representations of a scene, whereas a depth map contains spatial information for each pixel in a scene. In some embodiments, the generative-composition recommendation system 102 utilizes a vision machine learning model pre-trained for generating scene graphs (e.g., the multi-modal large language model 512) to generate a scene graph of the background image 504.

In one or more embodiments, the generative-composition recommendation system 102 generates/determines one or more bounding boxes from the predicted position (e.g., the position 516). In some embodiments, a bounding box 517 refers to a rectangular region that defines an area around an object or feature within an image. For example, the generative-composition recommendation system 102 defines the rectangular region by (x, y) and (w, h). Moreover, in some embodiments, the generative-composition recommendation system 102 generates a plurality of bounding boxes that indicate possible positions of a foreground object in a background image.

In some embodiments, the generative-composition recommendation system 102 generates a plurality of bounding boxes based on the background image 504 and the foreground object concept 506 and further generates corresponding confidence scores (e.g., generated by a bounding box machine learning model). In particular, the generative-composition recommendation system 102 selects the bounding box 517 from the plurality of bounding boxes based on the bounding box 517 having a relatively highest confidence score. In some embodiments, the confidence score represents a likelihood of the foreground object concept 506 being present in that region.

In some embodiments, the foreground object concept 506 is the text 508 describing the foreground object (e.g., a fountain head) and not the foreground image 510. In such cases, the generative-composition recommendation system 102 estimates how to put the foreground object (e.g., a fountain head) in the background image 504 and further estimates the position 516 of the foreground object in the background image 504. Accordingly, in some embodiments, the generative-composition recommendation system 102 utilizes a generative model to generate the foreground object (e.g., the fountain head) from the text of the predicted image composition 514.

Furthermore, FIG. 5 shows the generative-composition recommendation system 102 utilizing a generative rendering model 518 to generate a composite image 520. In particular, FIG. 5 shows the generative-composition recommendation system 102 utilizing the generative rendering model 518 to process the predicted image composition 514 to synthesize the foreground object concept 506 according to the position 516.

In one or more embodiments, the generative-composition recommendation system 102 generates the predicted image composition 514 that includes a text description of the composite image 520 and passes the predicted image composition 514 along with the background image 504, the foreground object concept 506, position information (e.g., bounding box coordinates, and average depth value of each object shown in a scene) to the generative rendering model 518.

In particular, the generative-composition recommendation system 102 generates a layout map based on the location and depth information of each object, which defines spatial positioning, geometrical relationships, and depth information for each object in a scene. In some embodiments, the generative-composition recommendation system 102 passes the layout map along with the background image 504 and the foreground image 510 to the generative rendering model 518 to generate the composite image 520.

In one or more embodiments, the composite image 520 refers to a single, unified image, created by the generative-composition recommendation system 102 combining a foreground image and the background image 504. In particular, the generative-composition recommendation system 102 generates the composite image 520 by merging multiple pieces of data (e.g., multiple images) together.

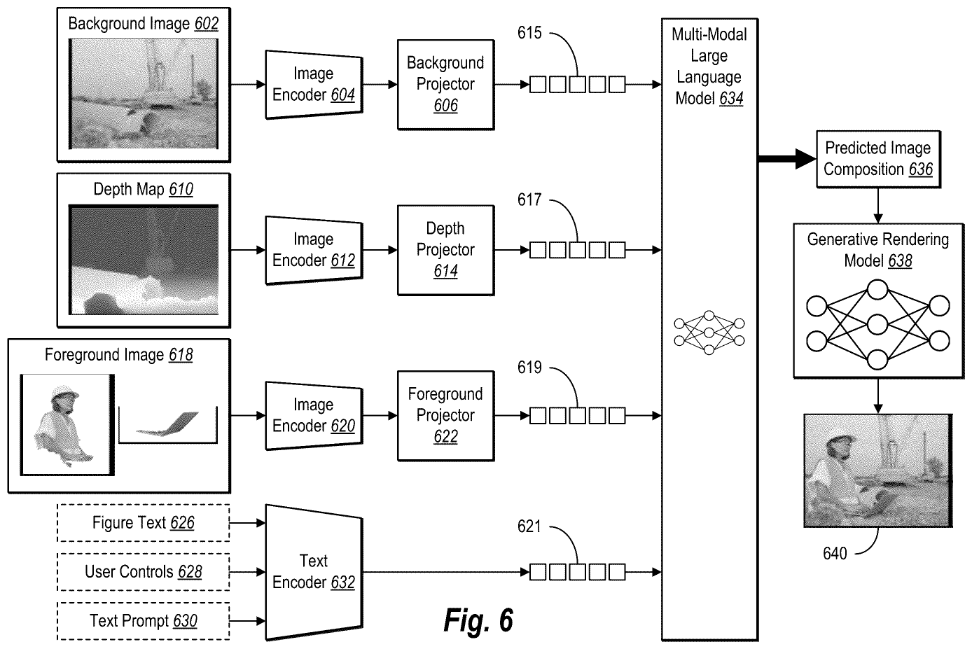

As mentioned above, the generative-composition recommendation system 102 utilizes separate projectors for different image types. As shown in FIG. 6, the generative-composition recommendation system 102 receives/accesses a background image 602, a depth map 610 of the background image, and a foreground image 618. Furthermore, FIG. 6 shows that in some embodiments, the generative-composition recommendation system 102 receives figure text 626, user control 628, and/or a text prompt 630.

In one or more embodiments, the depth map 610 refers to an image where each point (e.g., pixel) in the image represents a distance between a camera viewpoint (e.g., viewer) and a surface of the scene. In particular, the depth map 610 includes brighter pixels that correspond to points closer to the camera viewpoint and darker pixels that correspond to points farther from the camera viewpoint. In other words, the depth map 610 captures spatial depth information of a scene (e.g., the background image 602). To illustrate, in some embodiments, the generative-composition recommendation system 102 automatically generates a depth map when an image composition prompt includes the background image 602.

In one or more embodiments, the image composition prompt includes the figure text 626. In particular, the figure text 626 refers to a textual description of one or more of the provided image inputs. For example, the figure text 626 describes the background image 602 as a construction site and the figure text 626 further describes the foreground image 618 as a lady wearing construction equipment and a laptop.

In one or more embodiments, the image composition prompt includes the user controls 628. In particular, the user controls 628 refer to controls that guide a multi-modal large language model 634 to generate a predicted image composition 636. To illustrate, the generative-composition recommendation system 102 receives the user controls 628 such as “have the foreground image distant from the camera in the background image.”

As shown in FIG. 6, the generative-composition recommendation system 102 utilizes an image encoder 604 for the background image 602, an image encoder 612 for the depth map 610, an image encoder 620 for the foreground image 618 and a text encoder 632 for the figure text 626, the user controls 628, and the text prompt 630.

As highlighted above, the generative-composition recommendation system 102 further utilizes separate projectors for each image type. In particular, FIG. 6 shows the generative-composition recommendation system 102 utilizing a background projector 606 for the background image 602, a depth projector 614 for the depth map 610, and a foreground projector 622 for the foreground image 618. For example, the generative-composition recommendation system 102 utilizes separate projectors to project the image data from each image type into a unified embedding space.

Furthermore, in one or more embodiments, the generative-composition recommendation system 102 utilizes a projector to convert the image embeddings (e.g., the raw data) into image tokens. In other words, the generative-composition recommendation system 102 uses a projector to unify embeddings from the image domain with text tokens 621.

In one or more embodiments, a unified embedding space refers to a shared, high-dimensional vector space where data from the text and image modalities are mapped to consistent representations. In other words, the generative-composition recommendation system 102 transforms image data into data common and comparable with text data. Thus, the generative-composition recommendation system 102 transforms data into a unified embedding space to perform advanced reasoning tasks, such as generating a predicted image composition.

FIG. 6 shows the generative-composition recommendation system 102 utilizing separate projectors for each image type to generate image tokens (e.g., background image tokens 615, depth map tokens 617, and foreground image tokens 619). Moreover, FIG. 6 shows the generative-composition recommendation system 102 utilizing the multi-modal large language model 634 to generate the predicted image composition 636.

As mentioned above, the predicted image composition 636 includes a text description of how to composite an image with another image (e.g., depth and location of the foreground image 618). Furthermore, FIG. 6 shows the generative-composition recommendation system 102 utilizing a generative rendering model 638 to generate a composite image 640 from the predicted image composition 636.

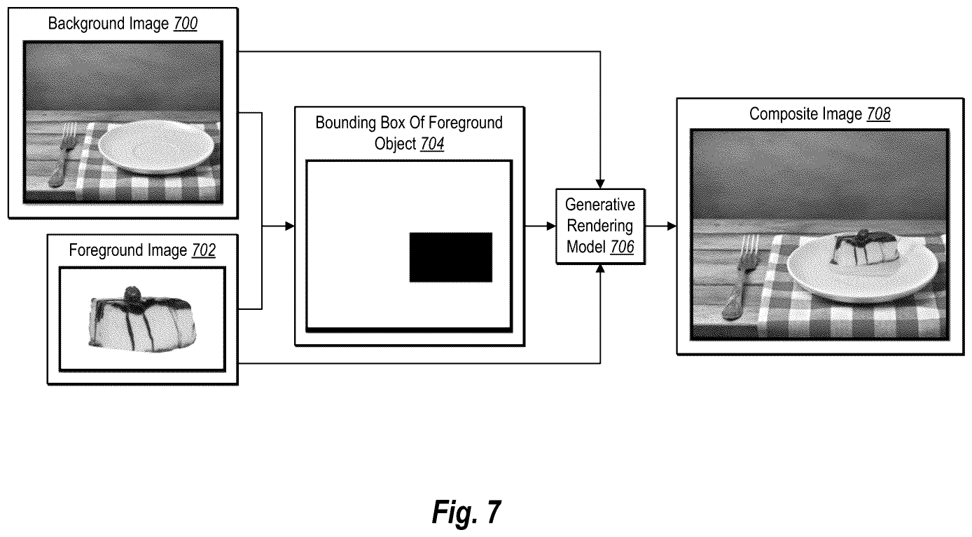

As mentioned above, the generative-composition recommendation system 102 utilizes a generative rendering model to render an object/background image from a predicted image composition and/or to combine multiple digital images. For example, FIG. 7 shows the generative-composition recommendation system 102 utilizing a generative rendering model to generate a composite image from a background image and a foreground image in accordance with one or more embodiments.

As shown in FIG. 7, the generative-composition recommendation system 102 receives/accesses a background image 700 and a foreground image 702. In particular, the background image 700 depicts a plate set at a dinner table and the foreground image depicts dessert (e.g., a cake). Moreover, in some embodiments, the generative-composition recommendation system 102 receives an image composition prompt with the background image 700 and/or the foreground image 702. Furthermore, the generative-composition recommendation system 102 generate a predicted image composition of inserting a foreground object into the background image 700 or generates a predicted image composition of a background image for the foreground image 702.

Additionally, as shown in FIG. 7, the generative-composition recommendation system 102 further determines a bounding box 704 of the foreground object in the background image 700. In particular, as discussed above, the generative-composition recommendation system 102 determines a location and a depth of the foreground image 702 in an appropriate location of the background image 700 (e.g., based on the fine-tuning of the multi-modal large language model. As shown in FIG. 7, based on the background image 700, the foreground image 702, and the bounding box 704 of the foreground object, the generative-composition recommendation system 102 utilizes a generative rendering model 706 to generate a composite image 708.

In one or more embodiments, a generative rendering model refers to a machine learning or computer vision model to combine multiple images or pieces of data together. In particular, the generative-composition recommendation system 102 utilizes the generative rendering model 706 to combine a background image with a foreground object according to a predicted position of the foreground object. Moreover, the generative rendering model 706 combines the multiple images or pieces of data in a consistent and natural manner. To illustrate, the generative-composition recommendation system 102 uses an object stitching model as the generative rendering model.

In some embodiments, the generative-composition recommendation system 102 utilizes a diffusion model as the generative rendering model 706. In one or more embodiments, the generative-composition recommendation system 102 utilizes a diffusion model to generate an object from a predicted image composition. In particular, if the predicted image composition suggests a specific foreground object to insert into the background image 700, the generative-composition recommendation system 102 further leverages a diffusion model to generate the foreground object. Moreover, as shown in FIG. 7, in some embodiments, the generative-composition recommendation system 102 utilizes a diffusion model to inpaint the foreground image 702 in the background image 700 according to the bounding box 704, to generate the composite image 708.

In one or more embodiments, the generative-composition recommendation system 102 utilizes the object stitching model. In particular, the generative-composition recommendation system 102 utilizes an object stitching model that includes a content adaptor and a generator (e.g., a pretrained text-to-image diffusion model) that produces a descriptive embedding of an input image (e.g., a description of a composite image).

Furthermore, the generative-composition recommendation system 102 takes the background image 700 as input to the diffusion portion of the model, and at each iteration (during denoising) the generative-composition recommendation system 102 applies a mask on the generated output image such that the generator only denoises the masked area.

In other words, the generative-composition recommendation system 102 masks an area in the background image 700 (e.g., the area on the plate where the cake would be placed). Further, the generative-composition recommendation system 102 uses the diffusion model to inpaint the foreground image 702 in the masked region of the background image 700 by conditioning denoising neural networks with the foreground image 702.

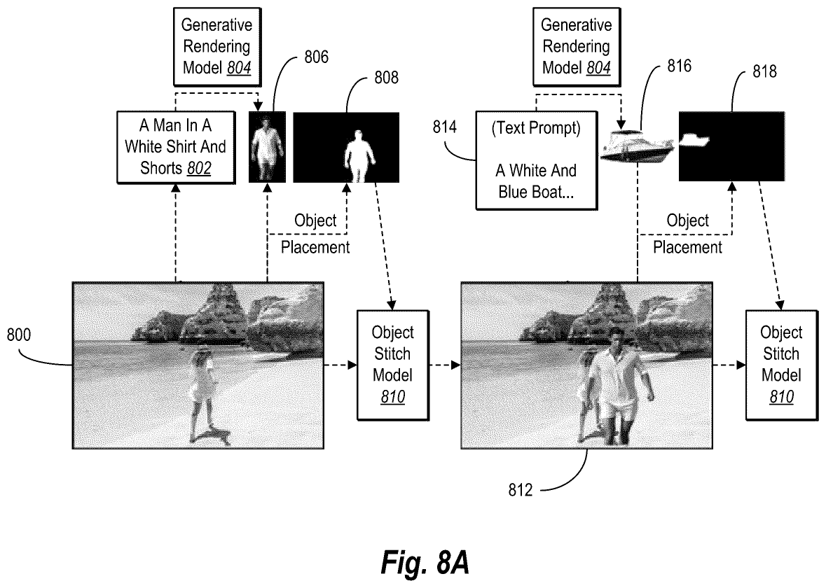

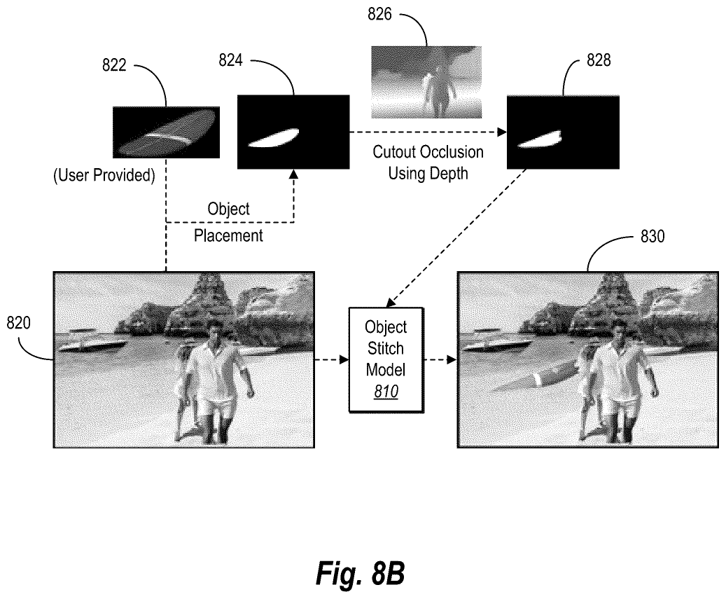

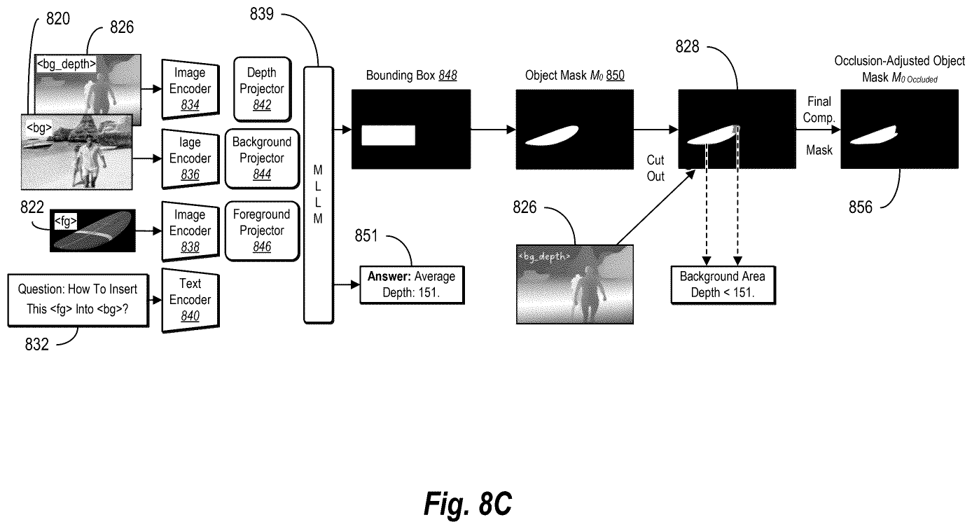

As alluded to above, the generative-composition recommendation system 102 improves accuracy and efficiency relative to existing systems by allowing for iterative modifications to a composite image and accurately determining how to position objects in an image. FIGS. 8A-8B illustrates multiple round interactions with the generative-composition recommendation system 102 and the generative-composition recommendation system 102 predicting a cutout occlusion of an object using a depth map in accordance with one or more embodiments.

In one or more embodiments, the generative-composition recommendation system 102 provides an option for multiple rounds of image composition prompts. In particular, multiple round interactions refer to iterative adjustments/modifications to a composite image. To illustrate, the generative-composition recommendation system 102 initially generate a composite image and further receives a prompt to add an additional object and/or modify existing elements within the composite image.

As shown in FIG. 8A, the generative-composition recommendation system 102 receives an image 800 that portrays a beach with a woman walking along the beach. Furthermore, FIG. 8A shows that in response to the image 800, the generative-composition recommendation system 102 generates a predicted image composition 802 that suggests generating “a man in a white shirt and shorts.” Further, FIG. 8A shows the generative-composition recommendation system 102 utilizing a generative rendering model 804 to synthesize/generate (e.g., using a diffusion model) a foreground object 806 that conforms with the predicted image composition 802.

Moreover, FIG. 8A shows the generative-composition recommendation system 102 determining an object placement 808 (e.g., based on a depth map of the image 800) of the foreground object 806. Further, FIG. 8A shows the generative-composition recommendation system 102 utilizing an object stitch model 810 to generate a composite image 812 based on the image 800, the foreground object 806 and the object placement 808. As shown, the composite image 812 depicts the initial image with the new foreground object synthesized in a natural and aesthetically pleasing manner.

Additionally, FIG. 8A shows the generative-composition recommendation system 102 receiving a text prompt 814 from a user of a computing device that reads “a white and blue boat.” FIG. 8A illustrates the iterative nature of creating composite images by additionally receiving the text prompt 814 and further generating a foreground object 816 using the generative rendering model 804. Moreover, FIG. 8A shows the generative-composition recommendation system 102 determining an object placement 818 of the foreground object 816.

Continuing on from FIG. 8A, FIG. 8B shows the generative-composition recommendation system 102 generating a composite image 820 from the composite image 812, the foreground object 816, and the object placement 818. In particular, FIG. 8B shows the composite image 820 as portraying the synthesized foreground object 806 and the synthesized foreground object 816 in a natural and aesthetically pleasing manner.

Moreover, FIG. 8B shows the generative-composition recommendation system 102 additionally receiving a visual prompt 822 (e.g., user provided prompt) from a user of a computing device. In particular, a user of a computing device submits an additional foreground object (e.g., the surfboard) to add to the composite image 820. As shown in FIG. 8B, the generative-composition recommendation system 102 determines an object placement 824 of the visual prompt 822 (e.g., the surfboard) in the composite image 820.

Furthermore, FIG. 8B shows the generative-composition recommendation system 102 determining a cutout occlusion 828 using a depth map 826 of the composite image 820. In one or more embodiments, the generative-composition recommendation system 102 generates a composite image where a cutout occlusion occurs. In particular, the cutout occlusion 828 refers to an object that is at least partially occluded within the image. For example, the object is at least partially occluded due to existing objects in the image or to existing elements within a background of the image. In particular, FIG. 8B shows the generative-composition recommendation system 102 generating the cutout occlusion 828 (e.g., a mask of how the surfboard object would appear) and using the cutout occlusion 828, the composite image 820 and the visual prompt 822 to generate a composite image 830 (e.g., using the object stitch model 810). To illustrate, FIG. 8B shows the composite image 830 as portraying the surfboard partially occluded by the woman and the water.

FIG. 8C provides additional details of the generative-composition recommendation system 102 determining the cutout occlusion. For example, FIG. 8C shows the generative-composition recommendation system 102 accessing the depth map 826 of the background image, the composite image 820 (e.g., a background image), the visual prompt 822 (e.g., the surfboard), and a text prompt 832 of “how to insert the foreground object into the background?” In particular, FIG. 8C shows the generative-composition recommendation system 102 utilizing an image encoder 834 to generate a feature map of the depth map 826, an image encoder 836 to generate a feature map of the composite image 820, and an image encoder 838 to generate a feature map of the visual prompt 822.

Moreover, FIG. 8C shows the generative-composition recommendation system 102 utilizing a depth projector 842 for the depth map 826, a background projector 844 for the composite image 820, and a foreground projector 846 for the visual prompt 822. As discussed above, the generative-composition recommendation system 102 utilizes separate projectors to generate image tokens compatible in a unified embedding space. Further, FIG. 8C shows the generative-composition recommendation system 102 utilizing a text encoder 840 to generate text tokens from the text prompt 832. Additionally, FIG. 8C shows the generative-composition recommendation system 102 utilizing a multi-modal large language model 839 to generate a bounding box 848 and depth 851 (e.g., average depth: 151 for the surfboard object of the visual prompt 822).

As further shown in FIG. 8C, the generative-composition recommendation system 102 utilizes the bounding box 848 to determine an object mask 850 of the visual prompt 822 (e.g., the foreground object). Moreover, based on the object mask 850 and the depth map 826, the generative-composition recommendation system 102 determines which parts of the object mask are occluded (e.g., the generative-composition recommendation system 102 generates the cutout occlusion 828).

Additionally, FIG. 8C shows that the generative-composition recommendation system 102 determines that the background area with depth is less than 151 (e.g., the average depth of the surfboard object). Further, FIG. 8C shows the generative-composition recommendation system 102 generates an occlusion-adjusted object mask 856 that captures depth information and position of the foreground object (e.g., the surfboard).

In one or more embodiments, the generative-composition recommendation system 102 computes the occlusion-adjusted object mask 856 (M_{O, occluded}) based on the predicted average depth value (d) of the object (e.g., the surfboard object from the visual prompt 822) and the depth map 826 of the background D_{B} (e.g., the composite image 820). In particular, given the initial binary object mask M_{O}, where M_{O}(x, y)=1, if the pixel (x, y) belongs to the surfboard object and 0 otherwise, the generative-composition recommendation system 102 determines the occlusion condition as d>D_{B}(x, y), implying that the surfboard object should be behind the background at those pixels (farther from the camera).

In some embodiments, the generative-composition recommendation system 102 updates the mask for each pixel (x, y) by checking if both M_{O}(x, y)=1 (indicating the pixel belongs to the surfboard object) and d>D_{B}(x, y). If both conditions are met, the generative-composition recommendation system 102 wipes out (removes) the corresponding pixel from the object mask. In some embodiments, the generative-composition recommendation system 102 represents the mathematical computation of the occlusion-adjusted object mask 856 as:

M_{o,occluded}(x, y)=Mₒ(x,y)· [symbol] [d≤D_{B}(x,y)],

Where [symbol] [d≤D_{B}(x, y)] is an indicator function which equals 1 if d≤D_{B}(x, y) and 0 otherwise. In particular, the above formulation ensures that the object mask M_{o,occluded} retains only the regions of the object where it is not occluded by the background image.

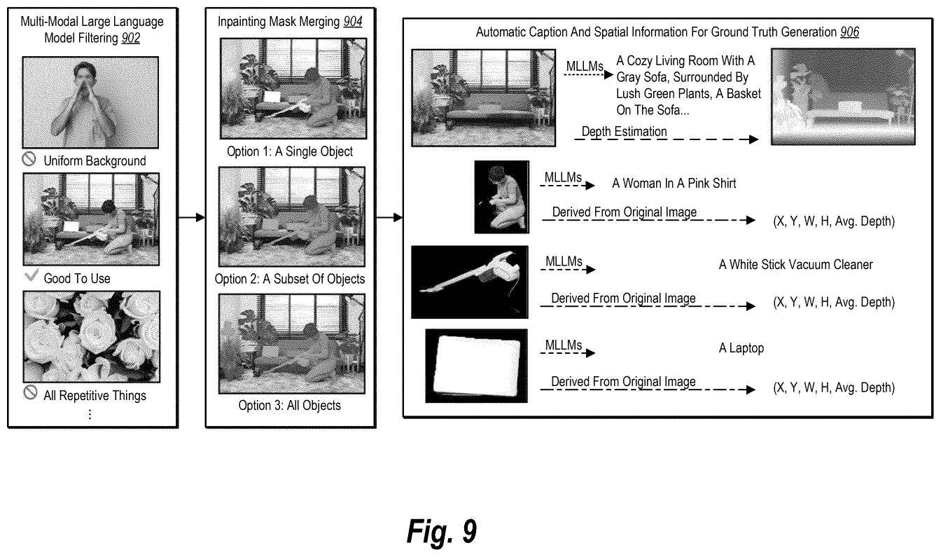

FIG. 9 illustrates an example diagram of the generative-composition recommendation system 102 using a data preprocessing pipeline to filter training data for fine-tuning a multi-modal large language model in accordance with one or more embodiments. For example, FIG. 9 illustrates an overview of the data preprocessing pipeline that starts with an internet-scale image database. In particular, FIG. 9 shows the generative-composition recommendation system 102 performing an act 902 of multi-modal large language model filtering to filter out images irrelevant to image composition tasks (e.g., images with a uniform background and images with repetitive patterns).

In some embodiments, the generative-composition recommendation system 102 filters out images by prompting a multi-modal large language model to exclude images with blank or uniform backgrounds and those with repetitive objects (e.g., as those images provide limited information for learning parameters of image composition tasks). In one or more embodiments, during fine-tuning of the multi-modal large language model, the generative-composition recommendation system 102 excludes 30% of the data (e.g., retains 70% of the data or 709K background images with over 1.3 million background-foreground pairs).

Further, FIG. 9 shows the generative-composition recommendation system 102 performing an act 904 of inpainting mask merging. In particular, to perform the act 904, the generative-composition recommendation system 102 generates entity segmentation masks. As shown in FIG. 9, the generative-composition recommendation system 102 generates a first entity segmentation mask in the top image that encompasses only the person kneeling down (e.g., a single object).

Moreover, FIG. 9 shows the generative-composition recommendation system 102 generating a second entity segmentation mask in the middle image that encompasses only the person kneeling down and the vacuum (a subset of objects) and a third entity segmentation mask in the bottom image that encompasses all objects shown in the image. In some embodiments, the generative-composition recommendation system 102 applies inpainting in one of the three randomly chosen modes (e.g., targeting a single object, a subset of objects, or all objects).

In doing so, the generative-composition recommendation system 102 creates background images with varying levels of object density, enhancing the learning capabilities/adaptability of the multi-modal large language model to diverse image composition prompts. Moreover, the generative-composition recommendation system 102 removes multiple objects simultaneously, which helps the multi-modal large language model from relying on potentially high-frequency artifacts in an inpainted region as shortcuts (which encourages more robust learning).

In one or more embodiments, the generative-composition recommendation system 102 performs object and effect removal from the background by using a layer-wise object removal to enhance data generation. In particular, existing methods struggle with leaving behind artifacts, shadows, and reflections which leads to overfitting of the multi-modal large language model during training.

In one or more embodiments, the generative-composition recommendation system 102 utilizes a random subset selection algorithm in inpainting mask merging. In some embodiments, for each image, the generative-composition recommendation system 102 assumes there are n object entities segmented out, resulting in n entity segmentation masks in total {m₁ . . . , mₙ}. In particular, if n is less than or equal to 2, the generative-composition recommendation system 102 does not select the subset, and adopts all the masks M.

In some embodiments, if n is greater than 2, the generative-composition recommendation system 102 first randomly selects a mask denoted as m_{rand}, and then selects the rest of the masks via location-based or size-based criteria. In some embodiments, the generative-composition recommendation system 102 defines a proximity selection probability p_{proximity} with a default value of 0.7. In particular, with probability p_{proximity}, the generative-composition recommendation system 102 follows location-based criteria for mask selection. In some embodiments, for each mask mᵢ∈M, the generative-composition recommendation system 102 computes the geometric center of the mask area (e.g., the white pixel area) and calculates the distance di with respect to the geometric center of m_{rand}.

In some embodiments, the generative-composition recommendation system 102 determines a mask selection priority list x by a sorted list of {dᵢ} with ascending order. Further, with probability 1−p_{proximity}, the generative-composition recommendation system 102 follows the size-based criteria for mask selection. In particular, for each mask mᵢ∈M, the generative-composition recommendation system 102 computes the size (e.g., number of pixels) of the mask area (e.g., the white pixel area) and calculates the difference with respect to the size of the mask difference (e.g., diffᵢ). Further, the generative-composition recommendation system 102 determines the mask selection priority list π by the sorted list of {diffᵢ} with ascending order.

Moreover, in some embodiments, with the mask selection priority list π, the generative-composition recommendation system 102 now performs mask subset selection with an aim to select more than one mask (e.g., the randomly selected mask m_{rand} must be already selected), and by default the generative-composition recommendation system 102 selects the top rᵢₙᵢₜᵢₐₗ=40% of the mask selection priority list. If the ratio does not give more than one selection, the generative-composition recommendation system 102 adds a ratio of 20% in a loop.

In one or more embodiments, the generative-composition recommendation system 102 utilizes a random mask subset selection described above as follows:

Algorithm 1 Random Mask subset Selection

| | |
|---|---|
| 1: | Input: |
| | • M: set of mask files {m₁...,mₙ} (n objects) |
| | • p_{proximity}: proximity selection probability |
| | • rᵢₙᵢₜᵢₐₗ: initial selection ratio (default = 0.4) |
| 2: | Initialization: |
| | • If \|M\| ≤ 2: return M |
| | • m_{rand} ← RandomSelect(M) |
| 3: | Mask Sorting: |
| 4: | if rand(0,1) < p_{proximity} then |
| 5: | for each mᵢ in M do |
| 6: | cᵢ ← ComputeCenter(mᵢ) |
| 7: | dᵢ ← ∥c_{rand} − cᵢ∥₂ |
| 8: | end for |
| 9: | π ← ArgsortAscending ({d₁...,dₙ}) |
| 10: | else |
| 11: | s_{rand} ← ComputeSize(m_{rand}) |
| 12: | for each m₁ in M do |
| 13: | sᵢ ← ComputeSize(mᵢ) |
| 14: | diffᵢ ← \|s_{rand} − sᵢ\| |
| 15: | end for |
| 16: | π ← ArgsortAscending ({diff₁...,diffₙ}) |
| 17: | end if |
| 18: | Mask Grouping: |
| 19: | r ← rᵢₙᵢₜᵢₐₗ |
| 20: | while \|I\| ≤ 1 do |
| 21: | k ← max (1, round(r x \|M\|)) |
| 22: | I ← UniqueSort(first k masks) |
| 23: | r ← min(r + 0.2, 1.0) |
| 24: | end while |
| 25: | return I |

Further, in some embodiments, the generative-composition recommendation system 102 generates training bundles for training the multi-modal large language model. In particular, the generative-composition recommendation system 102 generates training triplets, where for foreground predictions given a background, the generative-composition recommendation system 102 uses a bundle that include instructions, a background image, and a foreground caption.

Moreover, for background predictions given a foreground, the generative-composition recommendation system 102 uses a bundle that includes instructions, a foreground image, and a background caption. Further, for training the multi-modal large language model for controllable object placement (e.g., predicting location and depth), the generative-composition recommendation system 102 uses a bundle that includes instructions, background image, background depth, foreground image, foreground caption, control text (e.g., distant from camera), foreground bounding box, and foreground depth.

FIG. 9 shows the generative-composition recommendation system 102 performing an act 906 of automatic caption and spatial information for ground truth generation. In particular, the generative-composition recommendation system 102 separates the selected objects from the original image to create paired clean background images and isolated foreground objects. Moreover, the generative-composition recommendation system 102 automatically generates the dense captions for the clean background, captions each regional foreground object, and computes a depth map of the background.

As shown in FIG. 9, for the clean background image, the generative-composition recommendation system 102 utilizes a multi-modal large language model to generate a caption that reads “a cozy living room with a gray sofa, surrounded by lush green plants, a basket on the sofa . . . ” Moreover, as shown, the generative-composition recommendation system 102 utilizes a depth estimation model to process the clean background image and predict the depth of each pixel in the clean background image. In particular, the generative-composition recommendation system 102 utilizes a depth estimation model that extracts features from the input image (e.g., textures, edges, and shapes) and then generates a depth prediction for each feature. Moreover, the generative-composition recommendation system 102 utilizes the depth estimation model to output a depth map.

FIG. 9 further shows the generative-composition recommendation system 102 utilizing the multi-modal large language model to generate a caption of the person kneeling as “a woman in a pink shirt” and the location and depth of the person (e.g., x, y, w, h, average depth). Additionally, FIG. 9 shows the generative-composition recommendation system 102 generating the captions of “a white stick vacuum cleaner” and “a laptop” with corresponding location and depth information obtained from the original image.

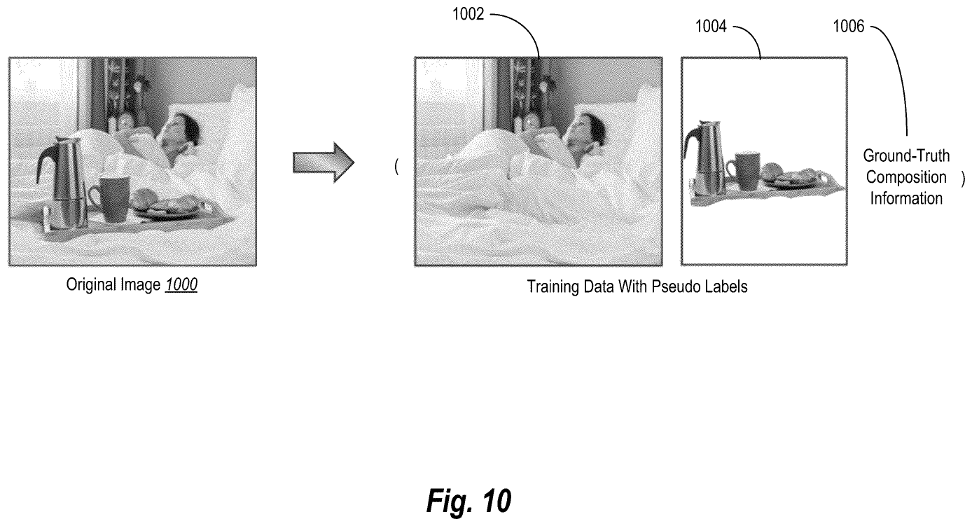

FIG. 10 illustrates an example diagram of the generative-composition recommendation system 102 generating training data with ground-truth composition information. For example, FIG. 10 shows what was described above with respect to creating a training bundle for training a multi-modal large language model. In particular, FIG. 10 shows an original image 1000 depicting a background of a bedroom with a person in bed and foreground objects (e.g., breakfast in bed items). Moreover, FIG. 10 shows that from the original image 1000, the generative-composition recommendation system 102 creates a clean background image 1002, a foreground image 1004, and ground-truth composition information 1006 (e.g., location and depth information obtained from the original image 1000 and a depth map of the original image 1000).

Additionally, in one or more embodiments, the generative-composition recommendation system 102 applies data augmentations to training bundles to further diversify the learning capabilities of a multi-modal large language model. For example, for both background and foreground images, the generative-composition recommendation system 102 adopts the following data augmentation types: color jittering, brightness transform, and downsampling.

In some embodiments, the generative-composition recommendation system 102 performs color jittering by using a color jittering transformation function. In particular, the generative-composition recommendation system 102 sets hyperparameters to contrast=0.25, saturation=0.25 and hue=01. Further, the generative-composition recommendation system 102 applies random color jittering for both background and foreground images.

In some embodiments, the generative-composition recommendation system 102 performs brightness adjustment augmentations to imitate uneven light projections from different directions and angles. In particular, the generative-composition recommendation system 102 designs a brightness transform function by creating a linear gradient mask and scaling its intensity. In some embodiments, the generative-composition recommendation system 102 uses the input image I(x, y), defined in the spatial domain with values normalized to [0, 1], where H and W represent the height and width of the image, respectively. Moreover, the generative-composition recommendation system 102 generates a linear gradient mask using spatial coord

$$u ( x ) = \frac{x}{W - 1} and v ( y ) = \frac{y}{H - 1}$$

for each pixel (x, y), combined as g(x, y)=u(x)cos(θ)+v(y)sin(θ), where θ is a randomly chosen angle in the range [0, 2π].

In some embodiments, the generative-composition recommendation system 102 normalizes the gradient to the range of [0, 1] as

$$g ’ ( x , y ) = \frac{g ( x , y ) - min ( g )}{max ( g ) - min ( g )} .$$

Further, to adjust the brightness, the normalized gradient is scaled to create a mask M(x, y)=0.7+g′(x, y)·0.6, which scales the brightness range to [0.7, 1.3]. Further, the generative-composition recommendation system 102 computes the adjusted image as I′(x, y)=min(I(x, y)·M(x, y), 1) to ensure all values remain within the valid range of [0, 1]. In doing so, the generative-composition recommendation system 102 effectively enhances or reduces brightness across the image based on a generated gradient. Therefore, in some embodiments, the generative-composition recommendation system 102 represents the augmented image as,

$${I}^{′} ( x , y ) = min ( I ( x , y ) \cdot ( 0.7 + \frac{g ( x , y ) - min ( g )}{max ( g ) - min ( g )} \cdot 0.6 ) , 1 ) ,$$

$$Where g ( x , y ) = u ( x ) cos ( θ ) + v ( y ) sin ( θ ) , u ( x ) = \frac{x}{W - 1} and v ( y ) = \frac{y}{H - 1} .$$

In some embodiments, for the foreground images in the training data, the generative-composition recommendation system 102 uses the highest resolution versions. Further, for background images, the generative-composition recommendation system 102 uses the version of data with short-edge resized to 1024. In particular, the resolutions for both the background and foreground images are large enough for the testing phase, and the generative-composition recommendation system 102 only needs to do downsampling for resolution adjustment data augmentation.

In some embodiments, the generative-composition recommendation system 102 adopts a continuous resolution value downsampling approach via resizing the long edge of each image to a random value between a pre-defined value (32 for foreground, 200 for background) and the minimum of the long edge dimension of the image. Further, in some embodiments, for background images, the generative-composition recommendation system 102 applies downsampling with a probability of 0.2 for each sample and for foreground images, the generative-composition recommendation system 102 applies downsampling with a probability of 0.5 for each sample.

In one or more embodiments, the generative-composition recommendation system 102 randomly inpaints multiple background regions in the background images. In particular, the generative-composition recommendation system 102 randomly inpaints multiple background regions to introduce high-frequency artifacts throughout the image before background data augmentation. To illustrate, the generative-composition recommendation system 102 randomly inpaints multiple background regions for around 78% of the background images. In some embodiments, the generative-composition recommendation system 102 samples free-form mask size ratios between 0.05 and 0.9.

As mentioned above, the generative-composition recommendation system 102 performs data augmentations to the obtained training data. In particular, the generative-composition recommendation system 102 performs data augmentations to overcome overfitting problems while training the multi-modal large language model. For example, in existing methods, paired foreground and background images from the same original image are perfectly harmonized in terms of lighting, contrast, and resolution, which allows the multi-modal large language model to exploit these low-level matching cues to predict placement. Moreover, in some embodiments, residual inpainting artifacts are present, which the multi-modal large language model also exploits. Thus, the data augmentations assist the generative-composition recommendation system 102 in avoiding overfitting problems.

As alluded to above, the generative-composition recommendation system 102 applies different random transformations to encourage the multi-modal large language model to focus on meaningful spatial and semantic relationships rather than relying on superficial visual clues. In one or more embodiments, experimenters performed an ablation study to compare augmented images with non-augmented images used for training purposes. In particular, the experimenters also performed an ablation study for bounding box parameterization. To illustrate, the experimenters found in their ablation study that training data that contains: finetuning instructions, location formatting, data augmentation, and separate projector weights led to the best FID (Frechet Inception Distance, used to evaluate the quality of images, where a lower score indicates better model performance).

| | | | | | | Mean |
|---|---|---|---|---|---|---|
| | | Instruction | | Separate | | Intersection |
| | Instruction | Location | Data | Projector | | over Union |
| Baseline | Finetuning | Format | Augmentation | Weight | FID | (IoU) |
| ✓ | x | x | x | x | 9.588 | 0.265 |
| ✓ | ✓ | x | x | x | 5.874 | 0.420 |
| ✓ | ✓ | ✓ | x | x | 5.725 | 0.448 |
| ✓ | ✓ | ✓ | ✓ | x | 5.049 | 0.478 |
| ✓ | ✓ | ✓ | ✓ | ✓ | 4.084 | 0.569 |

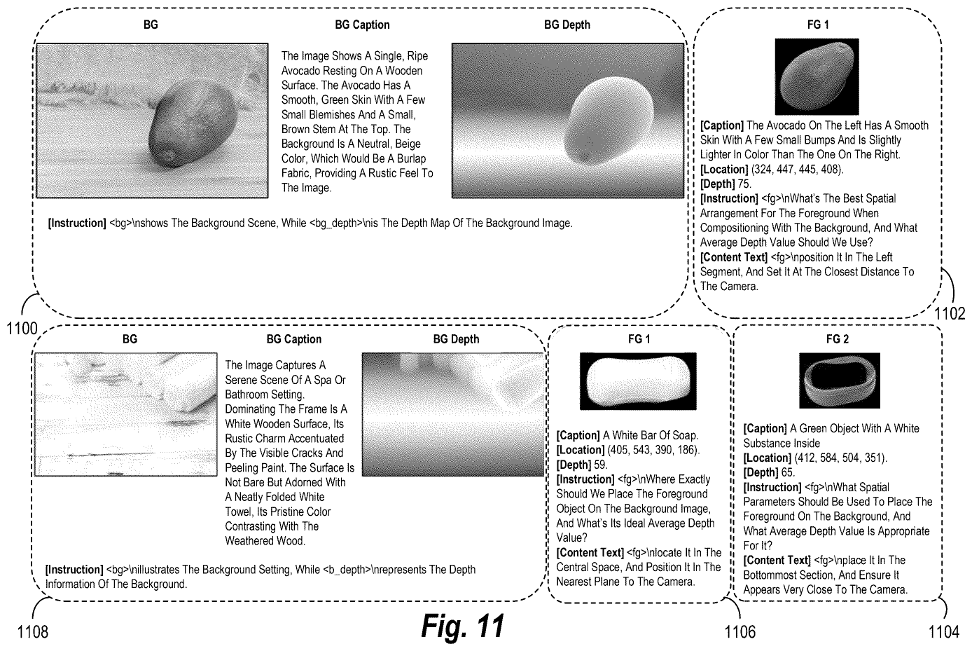

FIG. 11 illustrates an example diagram of the generative-composition recommendation system 102 generating training data pairs in accordance with one or more embodiments. For example, FIG. 11 shows a first training bundle 1100, a second training bundle 1102, a third training bundle 1104, a fourth training bundle 1106, and a fifth training bundle 1108. In particular, each training bundle is composed of one background image with related information and one or more foreground images with related information. Further, for each background image, the generative-composition recommendation system 102 generates a depth map.

Moreover, as mentioned above, the generative-composition recommendation system 102 generates a background caption for each training bundle by feeding the background image into a caption generation model and prompting the caption generation model with a question such as, “provide a detailed description of the scene in the image.” Moreover, the generative-composition recommendation system 102 utilizes a foreground caption generation model to generate captions for foreground images. In particular, the generative-composition recommendation system 102 circles out the object in a foreground image using an entity segmentation mask and instructs the foreground caption generation model to generate a description of the masked object.

In some embodiments, the generative-composition recommendation system 102 computes location data from the entity segmentation masks in the format of (x, y, w, h), where the coordinate values are normalized to a range of [0, 1000] with respect to a padded-to-square image. Moreover, the generative-composition recommendation system 102 computes the average depth value by calculating the average pixel depth value of the object area on the depth map of the original image.

In some embodiments, the generative-composition recommendation system 102 generate context texts by dividing the location information of each object into five types: top, bottom, left, right, and middle. Furthermore, in some embodiments, the generative-composition recommendation system 102 divides the depth information of each object into three types: near the camera, in the middle, and distant from the camera. In addition, the generative-composition recommendation system 102 generates corresponding controllable prompts for instruction tuning based on the location and depth type the object sample is classified as. In particular, the instructions for both background and foreground are generated using 16 synonym prompts for background description and composition querying respectively.

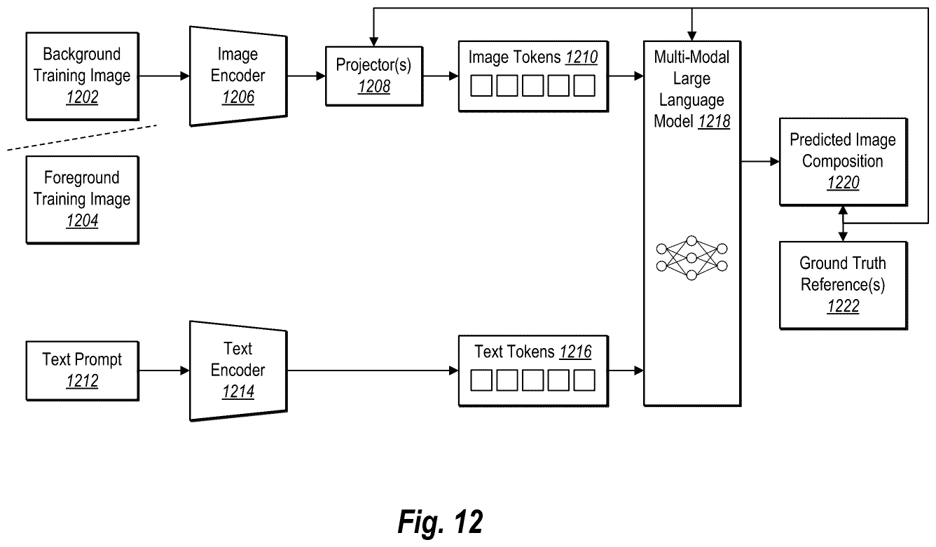

FIG. 12 illustrates an example diagram of the generative-composition recommendation system 102 modifying parameters of a multi-modal large language model in accordance with one or more embodiments. For example, FIG. 12 shows the generative-composition recommendation system 102 accessing/receiving a background training image 1202 and/or a foreground raining image 1204 and using an image encoder 1206 to extract feature map(s). Furthermore, the generative-composition recommendation system 102 utilizes projector(s) 1208 to generate image tokens 1210.

As also shown, the generative-composition recommendation system 102 utilizes a text encoder 1214 to generate text tokens 1216 from a text prompt 1212. Moreover, as shown, the generative-composition recommendation system 102 utilizes a multi-modal large language model 1218 to generate a predicted image composition 1220 from the image tokens 1210 and the text tokens 1216. Furthermore, as shown, the generative-composition recommendation system 102 compares the predicted image composition 1220 to a ground truth reference 1222 (e.g., containing a description of an image and/or position information).

As shown in FIG. 12, based on the comparison between the predicted image composition 1220 and the ground truth reference 1222, the generative-composition recommendation system 102 modifies parameters of the projector(s) 1208 and the multi-modal large language model 1218. In particular, all the projectors (e.g., background projector, foreground projector, and depth projector) and the multi-modal large language model 1218 are modifiable components of the architecture. In other words, during training/fine-tuning, the generative-composition recommendation system 102 updates parameters of the projector(s) 1208 and the multi-modal large language model 1218. Thus, each projector is fine-tuned for a respective image type to accurately generate image tokens for that image type.

In one or more embodiments, experimenters perform evaluations of the generative-composition recommendation system 102 on three datasets. For example, experimenters evaluate the generative-composition recommendation system 102 on an OPA dataset (object-placement-assessment), a large corpus of stock images set, and an in-the-wild set. In particular, the OPA dataset includes 62,074 training images (21,376 positive and 40,698 negative) and 11,396 testing images (3,588 positive and 7,808 negative). Moreover, all images are sampled and selected from a dataset where each composite image is composed of one background, one object, and one composition bounding box.

Furthermore, positive samples feature foreground and background compositions that are deemed compatible, while negative samples contain mismatched compositions. For a fair comparison on OPA, the experimenters train the multi-modal large language model for object placement using only the positive samples, which constitute approximately one-third of the training set. Moreover, the experimenters evaluated the OPA on a validation set that includes 3,588 images, using the FID score calculated between the positive testing images and copy-and-pasted composites.

Further, the large corpus of stock images set is obtained by sampling 10K images from a large corpus of stock images and performing the process described above in FIG. 9 to generate background and foreground pairs. In particular, the 10K testing set has no overlap with the training distribution and are samples with only one foreground selected. Since the background and foreground images are originally from the same image, the experimenters have the ground truth bounding boxes for evaluation.

Additionally, the experimenters adopt a classic mean intersection over union as an evaluation metric of the large corpus of stock images set. In some embodiments, the experimenters test the content recommendation performance by randomly selecting 1K from the 10K data and performing foreground and background recommendations. In particular, the experimenters evaluate scores of the suggested captions with respect to ground truth captions. Further, experimenters evaluate scores of generated images with respect to ground truth images.

Moreover, the experimenters test the performance of the generative-composition recommendation system 102 on an in-the-wild test set by collecting a set of 383 image background foreground pairs (65 scenes) with compatible semantics. Due to the lack of ground truth location and human annotations in the in-the-wild test set, the experimenters conduct a user study, which reflects the human's satisfactory rate of reasonability, plausibility and aesthetics of the composited images. Specifically, experimenters collect preference results of various volunteers on randomly selected background foreground pairs from the in-the-wild dataset. The table below illustrates the above discussed experiments.

| | | | Large | Large | |
|---|---|---|---|---|---|
| | OPA - | OPA- | Corpus- | Corpus- | In-the-wild |
| Methods | FID | CMMD | FID | mean IoU | Satisfactory |
| Random | 31.93 | 0.118 | 11.98 | 0.160 | 0.078 |
| Sampling | | | | | |
| (1) TERSE | 46.94 | 0.060 | 6.209 | 0.223 | 0.056 |
| (2) PlaceNet | 36.69 | 0.039 | 7.326 | 0.204 | 0.139 |
| (3) GracoNet | 27.75 | 0.051 | 5.963 | 0.255 | 0.115 |
| (4) TopNet | 23.49 | 0.021 | 14.68 | 0.115 | 0.177 |
| (5) IORPE | 21.59 | — | — | — | — |
| (6) LLaVA-1.5- | 51.53 | 0.317 | 9.588 | 0.265 | 0.117 |
| 13B | | | | | |
| (7) Intern VL- | 34.33 | 0.193 | 13.89 | 0.236 | 0.058 |
| 2.0-26B | | | | | |
| (8) GPT-4o | 23.08 | 0.017 | 10.32 | 0.195 | 0.290 |
| Generative- | 15.07 | 0.017 | 4.084 | 0.569 | 0.321 |
| composition | | | | | |
| recommendation | | | | | |
| system 102 | | | | | |

In the above table, the (1) TERSE method is described in Shashank Tripathi, Siddhartha Chandra, Amit Agrawal, Ambrish Tyagi, James M Rehg, and Visesh Chari, Learning to generate synthetic data via compositing, In Proceedings of the IEEE/CVF Conference on Computer Vision and Pattern Recognition, pages 461-470, 2019. The (2) PlaceNet method is described in Lingzhi Zhang, Tarmily Wen, Jie Min, Jiancong Wang, David Han, and Jianbo Shi, Learning object placement by inpainting for compositional data augmentation, In Computer vision-ECCV 2020: 16^{th} European Conference, Glasgow, UK, Aug. 23-28, 2020, Proceedings, Part XIII 16, pages 566-581, Springer, 2020.

The (3) GracoNet method is described in Siyuan Zhou, Liu Liu, Li Niu, and Liqing Zhang, Learning object placement via dual-path graph completion, In European Conference on Computer Vision, pages 373-389, Springer, 2022. The (4) TopNet method is described in Sijie Zhu, Zhe Lin, Scott Cohen, Jason Kuen, Zhifei Zhang, and Chen Chen, Topnet: Transformer-based object placement network for image composition, In Proceedings of the IEEE/CVF Conference on Computer Vision and Pattern Recognition, pages 1838-1847, 2023.

The (5) IORPE method is described in Shengping Zhang, Quanling Meng, Qinglin Liu, Liqiang Nie, Bineng Zhong, Xiaopeng Fan, and Rongrong Ji, Interactive object placement with reinforcement learning, ICML, 2023. The (6) LLaVA-1.5-13B method is described in Haotian Liu, Chunyuan Li, Yuheng Li, and Yong Jae Lee, Improved baselines with visual instruction tuning, In Proceedings of the IEEE/CVF Conference on Computer vision and Pattern Recognition, pages 26296-26306, 2024. The (7) InternVL-2.0-26B method is described in Zhe Chen, Weiyun Wang, Hao Tian, Shenglong Ye, Zhang Wei Gao, Erfei Cui, Wenwen Tong, Kongzhi Hu, Jiapeng Luo, Zheng Ma, et al., How far are we to gpt-4v? closing the gap to commercial multimodal models with open-source suits, arXiv preprint arXiv: 2404.16821, 2024. The (8) GPT-4o method is described in OpenAI, Gpt-4o: A multimodal ai model, 2024.

The above table shows the various methods scored by FID, CMMD, meanIoU, and Satisfactory. As mentioned above, the lower the FID score, the better the performance of the model. Likewise, a lower CMMD (conditional maximum mean discrepancy score evaluates a distributional distance between two sets of data distributions) indicates a better performance of the model. In contrast, a higher meanIoU and a higher satisfactory score indicates better performance by a model. The above table shows that the generative-composition recommendation system 102 outperforms the other methods with respect to testing for each of the OPA, large corpus of stock images, and the in-the-wild test set.

The below table further shows an evaluation of compositional content recommendation tasks on the validation set of a large corpus of stock images dataset. In the BERT score, the P denotes precision, the R denotes recall, and F1 denotes an F-1 score. A higher BERT score and CLIP score indicates better performance by a model. In particular, a BERT score (bidirectional encoder representations from transformers) is obtained by using a pre-trained model to capture the semantic meaning of words in context (e.g., context-dependent embeddings) and comparing the embeddings of generated text (e.g., the predicted image composition) with a reference (e.g., ground truth). Further, a CLIP score (contrastive language-image pretraining) is obtained by using a pre-trained model to evaluate an alignment between images and text descriptions.

| | Background-to- | | Foreground-to- | |
|---|---|---|---|---|
| | foreground | Background-to- | Background | Foreground-to- |
| | BERT score | foreground | BERT score | Background |
| Model | (P/R/F1) | CLIP Score | (P/R/F1) | CLIP score |
| LLaVA-1.5-13B | 0.833/0.851/0.842 | 0.640 | 0.852/0.848/0.850 | 0.560 |
| InternVL-2.0-26B | 0.860/0.877/0.868 | 0.640 | 0.859/0.845/0.852 | 0.663 |
| GPT-4o | 0.848/0.873/0.860 | 0.647 | 0.858/0.846/0.852 | 0.664 |
| Generative- | 0.917/0.915/0.916 | 0.678 | 0.884/0.883/0.883 | 0.709 |
| composition | | | | |
| recommendation | | | | |
| system 102 | | | | |

In the above table, LLaVA-1.5-13B is described in Haotian Liu, Chunyuan Li, Yuheng Li, Bo Li, Yuanhan Zhang, Sheng Shen, and Yong Jae Lee, Llava-next: Improved reasoning, ocr, and world knowledge, 2024. InternVL-2.0-26B is described in Zhe Chen, Jiannan Wu, Wenhai Wang, Weijie Su, Guo Chen, Sen Xing, Muyan Zhong, Qinglong Zhang, Xizhou Zhu, Lewei Lu, et al, Internvl: Scaling up vision foundation models and aligning for generic visual-linguistic tasks, In Proceedings of the IEEE/CVF Conference on Computer Vision and Pattern Recognition, pages 24185-24198, 2024.

The above table shows that for background-to-foreground compositional content recommendation tasks, the generative-composition recommendation system 102 outperforms the other models in terms of both BERT score and CLIP score. Likewise, the generative-composition recommendation system 102 outperforms other models for foreground-to-background compositional content recommendation tasks for both BERT score and CLIP score.

Turning to FIG. 13, additional detail will now be provided regarding various components and capabilities of the generative-composition recommendation system 102. In particular, FIG. 13 illustrates an example schematic diagram of a computing device 1300 (e.g., the server device(s) 104 and/or the client device 112) implementing the generative-composition recommendation system 102 in accordance with one or more embodiments of the present disclosure for components 1300-1310. As illustrated in FIG. 13, the generative-composition recommendation system 102 includes an image composition prompt manager 1302, a predicted image composition manager 1304, a multi-modal large language model 1306, a composite image manager 1308, and a storage manager 1310.

The image composition prompt manager 1302 provides an option for a user of a computing device to submit a prompt. For example, the image composition prompt manager 1302 receives/accesses an image composition prompt submitted from a user of a computing device. Specifically, the image composition prompt manager 1302 receives a prompt that includes a variety of inputs, such as a background image, a foreground image, and/or various text inputs. For instance, the image composition prompt manager 1302 separates the different data components of an image composition prompt and passes the different data components to their appropriate architectural counterparts.

The predicted image composition manager 1304 receives an image composition prompt from the image composition prompt manager 1302. Specifically, the predicted image composition manager 1304 works with the multi-modal large language model 1306 to generate tokens and further oversees the generation of a predicted image composition from the tokens. Furthermore, the predicted image composition manager 1304 determines whether to generate content recommendations and/or object placement recommendations responsive to an image composition prompt.

The multi-modal large language model 1306 utilizes separate projectors to generate tokens for different image types. Specifically, the multi-modal large language model 1306 generates background image tokens, foreground image tokens, and/or depth image tokens. In doing so, the multi-modal large language model 1306 further works with the predicted image composition manager 1304 to generate a predicted image composition. Thus, the multi-modal large language model 1306 embeds information from an image composition prompt into a unified embedding space and determines best how to arrange image elements in a composite image.

The composite image manager 1308 generates a composite image. Specifically, the composite image manager 1308 receives a predicted image composition and combines various images together. For instance, the composite image manager 1308 receives a predicted image composition and transforms the predicted image composition into an image (e.g., synthesizes a foreground object). Moreover, the composite image manager 1308 leverages various generative models (e.g., diffusion models or object stitching models) to put together background images with foreground objects in appropriate positions (e.g., appropriate depth and location).

The storage manager 1310 stores various components discussed in FIG. 13. For example, the storage manager 1310 stores the image composition prompt (e.g., which contains background images, foreground images and/or text prompts), the multi-modal large language model 1306, parameters of the multi-modal large language model 1306, training data bundles, predicted image compositions, and composite images.

Each of the components 1300-1310 of the generative-composition recommendation system 102 include software, hardware, or both. For example, the components 1300-1310 include one or more instructions stored on a computer-readable storage medium and executable by processors of one or more computing devices, such as a client device or server device. When executed by the one or more processors, the computer-executable instructions of the generative-composition recommendation system 102 cause the computing device(s) to perform the methods described herein. Alternatively, the components 1300-1310 include hardware, such as a special-purpose processing device to perform a certain function or group of functions. Alternatively, the components 1300-1310 of the generative-composition recommendation system 102 include a combination of computer-executable instructions and hardware.

Furthermore, the components 1300-1310 of the generative-composition recommendation system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1300-1310 of the generative-composition recommendation system 102 may be implemented as a stand-alone application, such as a desktop or mobile application. Furthermore, the components 1300-1310 of the generative-composition recommendation system 102 may be implemented as one or more web-based applications hosted on a remote server. Alternatively, or additionally, the components 1300-1310 of the generative-composition recommendation system 102 may be implemented in a suite of mobile device applications or “apps.” For example, in one or more embodiments, the generative-composition recommendation system 102 comprise or operate in connection with digital software applications such as ADOBE® PHOTOSHOP, ADOBE® LIGHTROOM, ADOBE® PHOTOSHOP MOBILE, ADOBE® PHOTOSHOP CC, and ADOBE® PHOTOSHOP EXPRESS.

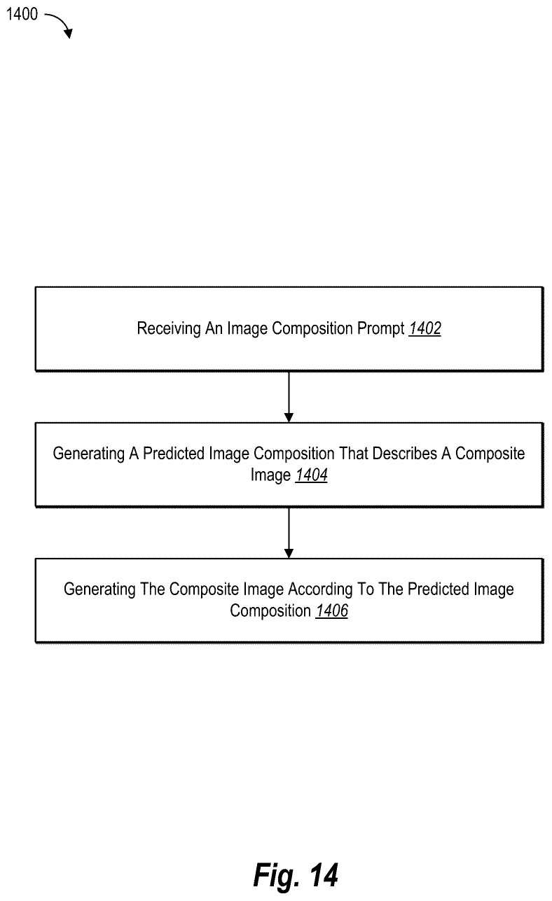

FIGS. 1-13, the corresponding text, and the examples provide a number of different methods, systems, devices, and non-transitory computer-readable media of the components 1302-1310. In addition to the foregoing, one or more embodiments are described in terms of flowcharts comprising acts for accomplishing the particular result. For example, FIG. 14 illustrates a flowchart of example sequences of acts in accordance with one or more embodiments.

FIG. 14 illustrates a flowchart of a series of acts 1400 for generating a predicted image composition in accordance with one or more embodiments. FIG. 10 illustrates acts according to one embodiment, alternative embodiments may omit, add to, reorder, and/or modify any of the acts shown in FIG. 14. In some implementations, the acts of FIG. 14 are performed as part of a method. For example, in some embodiments, the acts of FIG. 14 are performed as part of a computer-implemented method. Alternatively, a non-transitory computer-readable medium stores instructions thereon that, when executed by at least one processor, cause a computing device to perform the acts of FIG. 14. In some embodiments, a system performs the acts of FIG. 14. For example, in one or more embodiments, a system includes at least one memory device. The system further includes at least one server device configured to cause the system to perform the acts of FIG. 14.

The series of acts 1400 includes an act 1402 of receiving an image composition prompt. Further, the series of acts 1400 includes an act 1404 of generating a predicted image composition that describes a composite image. Moreover, the series of acts 1400 includes an act 1406 of generating the composite image according to the predicted image composition. In particular, the act 1402 includes receiving an image composition prompt comprising a background image or a foreground image and a text prompt. Further, the act 1404 includes based on the image composition prompt, generating, utilizing a multi-modal large language model, a predicted image composition that describes a composite image. Moreover, the act 1406 includes generating the composite image based on the background image or the foreground image modified according to the predicted image composition.

For example, in one or more embodiments, the series of acts 1400 includes generating, utilizing a text encoder of the multi-modal large language model, text tokens from the text prompt. In addition, in one or more embodiments, the series of acts 1400 includes extracting, utilizing an image encoder of the multi-modal large language model, a feature map from the background image or the foreground image. Further, in one or more embodiments, the series of acts 1400 includes generating, utilizing a background projector or a foreground projector of the multi-modal large language model, background image tokens or foreground image tokens.

Further, in some embodiments, the series of acts 1400 includes receiving the image composition prompt comprises receiving a text description of the background image or the foreground image. Moreover, in one or more embodiments, the series of acts 1400 includes receiving the image composition prompt comprises receiving user controls that guide the predicted image composition. Further, in one or more embodiments, the series of acts 1400 includes generating the predicted image composition comprises generating the predicted image composition from the text description and the user controls.

Moreover, in one or more embodiments, the series of acts 1400 includes generating a prediction of an object to insert within the background image at a predicted depth. Further, in one or more embodiments, the series of acts 1400 includes generating a depth map from the background image of the image composition prompt. Moreover, in one or more embodiments, the series of acts 1400 includes generating, utilizing a depth projector of the multi-modal large language model, depth tokens from the depth map. Additionally, in one or more embodiments, the series of acts 1400 includes generating the predicted image composition based on the depth tokens.

In one or more embodiments, the series of acts 1400 includes generating a first text prediction of a foreground object to insert within the background image of the image composition prompt. Moreover, in one or more embodiments, series of acts 1400 includes generating a second text prediction of a predicted background to combine with the foreground image of the image composition prompt. In one or more embodiments, the series of acts 1400 includes generating a predicted position of a foreground object to insert within the background image of the image composition prompt. In one or more embodiments, the series of acts 1400 includes wherein the predicted position of the foreground object comprises a bounding box for the foreground object in the background image of the image composition prompt.

In addition, in one or more embodiments, the series of acts 1400 includes generating, utilizing a generative rendering model to process text tokens of the predicted image composition, a foreground object combined with the background image. Further, in one or more embodiments, the series of acts 1400 includes generating, utilizing the generative rendering model to process the text tokens of the predicted image composition, a predicted background image combined with the foreground image. Further, in some embodiments, the series of acts 1400 includes utilizing an object stitching model to stitch together the background image or the foreground image with an image accessed based on the predicted image composition.

Moreover, in some embodiments, the series of acts 1400 includes receiving an image composition prompt comprising a background image and a foreground object concept. In one or more embodiments, the series of acts 1400 includes generating, utilizing a multi-modal large language model, a predicted image composition from the image composition prompt, the predicted image composition comprising a position of the foreground object concept in the background image. Furthermore, in one or more embodiments, the series of acts 1400 includes generating a composite image according to the position of the foreground object concept in the background image.

Moreover, in one or more embodiments, the series of acts 1400 includes receiving the foreground object concept comprises receiving a text description of the foreground object concept. Moreover, in one or more embodiments, the series of acts 1400 generating the predicted image composition by generating, utilizing a text encoder of the multi-modal large language model, text tokens of the foreground object concept. Further, in one or more embodiments, the series of acts 1400 includes extracting, utilizing an image encoder of the multi-modal large language model, a feature map from the background image.

In one or more embodiments, the series of acts 1400 includes generating, utilizing a background projector of the multi-modal large language model, background image tokens from the feature map. Moreover, in one or more embodiments, the series of acts 1400 includes wherein the background image tokens and the text tokens are in a unified embedding space of the multi-modal large language model. Further, in one or more embodiments, the series of acts 1400 includes generating the predicted image composition from the background image tokens and the text tokens of the foreground object concept.

Moreover, in some embodiments, the series of acts 1400 includes generating a depth map from the background image of the image composition prompt. Further, in some embodiments, the series of acts 1400 includes generating a prediction of the foreground object concept to insert within the background image at a predicted depth based on the depth map from the background image. Moreover, in some embodiments, the series of acts 1400 includes generating a plurality of bounding boxes for positions of the foreground object concept in the background image of the image composition prompt. Furthermore, in one or more embodiments, the series of acts 1400 includes selecting a bounding box from the plurality of bounding boxes, wherein the bounding box indicates the position of the foreground object concept in the background image. Moreover, in one or more embodiments, the series of acts 1400 includes generating the predicted image composition from the selected bounding box indicating the position of the foreground object concept.

Further, in one or more embodiments, the series of acts 1400 includes providing the composite image comprising the foreground object concept stitched together with the background image according to the position. In one or more embodiments, the series of acts 1400 includes receiving an additional image composition prompt comprising an additional foreground object. In addition, in one or more embodiments, the series of acts 1400 includes based on a depth map of the background image, determining a cutout occlusion of the additional foreground object in the composite image. Further, in one or more embodiments, the series of acts 1400 includes generating an additional composite image comprising the foreground object concept and the additional foreground object stitched together with the background image according to the cutout occlusion.

Further, in some embodiments, the series of acts 1400 includes generating, utilizing a background projector of a multi-modal large language model, a set of background tokens for a background image of a text prompt. Furthermore, in one or more embodiments, the series of acts 1400 includes generating, utilizing a foreground projector of the multi-modal large language model, a set of foreground tokens for a foreground image of the text prompt. Moreover, in one or more embodiments, the series of acts 1400 includes generating, utilizing the multi-modal large language model, a predicted image composition from the set of background tokens and the set of foreground tokens.

Further, in one or more embodiments, the series of acts 1400 includes generating, utilizing a depth estimation model, a depth map from the background image of the text prompt. Further, in some embodiments, the series of acts 1400 generating, utilizing a depth projector of the multi-modal large language model, a set of depth tokens from the depth map. Furthermore, in one or more embodiments, the series of acts 1400 includes generating the predicted image composition of the foreground image to insert within the background image at a predicted depth based on the set of depth tokens.

Furthermore, in one or more embodiments, the series of acts 1400 includes generating, utilizing a text encoder of the multi-modal large language model, text tokens from the text prompt. Moreover, in one or more embodiments, the series of acts 1400 includes generating the predicted image composition from the set of background tokens, the set of foreground tokens, and the text tokens, wherein the text tokens indicate user controls to guide a generation of the predicted image composition.

In one or more embodiments, the series of acts 1400 includes generating a plurality of bounding boxes for positions of the foreground image in the background image according to the text prompt and a depth map of the background image. In one or more embodiments, the series of acts 1400 selecting a bounding box indicating a position of the foreground image in the background image. In one or more embodiments, the series of acts 1400 includes generating the predicted image composition from the selected bounding box indicating the position of the foreground image. In one or more embodiments, the series of acts 1400 includes stitching the foreground image with the background image according to the predicted image composition to generate a composite image. In one or more embodiments, the series of acts 1400 includes providing the composite image to a user of a computing device. In one or more embodiments, the series of acts 1400 includes receiving an additional image composition prompt to modify the composite image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., the server device(s) 104 and/or the client device 112). In one or more embodiments, the computing device 1500 may be a mobile device (e.g., a mobile telephone, a smartphone, a PDA, a tablet, a laptop, a camera, a tracker, a watch, a wearable device). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 include hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 including storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving an image composition prompt comprising a background image or a foreground image and a text prompt;
based on the image composition prompt, generating, utilizing a multi-modal large language model, a predicted image composition that describes a composite image; and
generating the composite image based on the background image or the foreground image modified according to the predicted image composition.

2. The computer-implemented method of claim 1, wherein generating the predicted image composition comprises:
generating, utilizing a text encoder of the multi-modal large language model, text tokens from the text prompt;
extracting, utilizing an image encoder of the multi-modal large language model, a feature map from the background image or the foreground image; and
generating, utilizing a background projector or a foreground projector of the multi-modal large language model, background image tokens or foreground image tokens.

3. The computer-implemented method of claim 1, wherein:
receiving the image composition prompt comprises receiving a text description of the background image or the foreground image;
receiving the image composition prompt comprises receiving user controls that guide the predicted image composition; and
generating the predicted image composition comprises generating the predicted image composition from the text description and the user controls.

4. The computer-implemented method of claim 1, wherein generating the predicted image composition comprises generating a prediction of an object to insert within the background image at a predicted depth.

5. The computer-implemented method of claim 4, further comprising:
generating a depth map from the background image of the image composition prompt;
generating, utilizing a depth projector of the multi-modal large language model, depth tokens from the depth map; and
generating the predicted image composition based on the depth tokens.

6. The computer-implemented method of claim 1, wherein generating the predicted image composition comprises:
generating a first text prediction of a foreground object to insert within the background image of the image composition prompt; or
generating a second text prediction of a predicted background to combine with the foreground image of the image composition prompt.

7. The computer-implemented method of claim 1, wherein generating the predicted image composition comprises:
generating a predicted position of a foreground object to insert within the background image of the image composition prompt,
wherein the predicted position of the foreground object comprises a bounding box for the foreground object in the background image of the image composition prompt.

8. The computer-implemented method of claim 1, wherein generating the composite image from the predicted image composition comprises:
generating, utilizing a generative rendering model to process text tokens of the predicted image composition, a foreground object combined with the background image; or
generating, utilizing the generative rendering model to process the text tokens of the predicted image composition, a predicted background image combined with the foreground image.

9. The computer-implemented method of claim 1, wherein generating the composite image comprises utilizing an object stitching model to stitch together the background image or the foreground image with an image accessed based on the predicted image composition.

10. A system comprising:
one or more memory devices; and
one or more processors coupled to the one or more memory devices that cause the system to perform operations comprising:
receiving an image composition prompt comprising a background image and a foreground object concept;
generating, utilizing a multi-modal large language model, a predicted image composition from the image composition prompt, the predicted image composition comprising a position of the foreground object concept in the background image; and
generating a composite image according to the position of the foreground object concept in the background image.

11. The system of claim 10, wherein:
receiving the foreground object concept comprises receiving a text description of the foreground object concept; and
generating the predicted image composition by:
generating, utilizing a text encoder of the multi-modal large language model, text tokens of the foreground object concept; and
extracting, utilizing an image encoder of the multi-modal large language model, a feature map from the background image.

12. The system of claim 11, wherein generating the predicted image composition comprises:
generating, utilizing a background projector of the multi-modal large language model, background image tokens from the feature map,
wherein the background image tokens and the text tokens are in a unified embedding space of the multi-modal large language model; and
generating the predicted image composition from the background image tokens and the text tokens of the foreground object concept.

13. The system of claim 11, wherein generating the predicted image composition comprising the position of the foreground object concept in the background image by:
generating a depth map from the background image of the image composition prompt; and
generating a prediction of the foreground object concept to insert within the background image at a predicted depth based on the depth map from the background image.

14. The system of claim 10, further comprising:
generating a plurality of bounding boxes for positions of the foreground object concept in the background image of the image composition prompt;
selecting a bounding box from the plurality of bounding boxes, wherein the bounding box indicates the position of the foreground object concept in the background image; and
generating the predicted image composition from the selected bounding box indicating the position of the foreground object concept.

15. The system of claim 10, further comprising:
providing the composite image comprising the foreground object concept stitched together with the background image according to the position;
receiving an additional image composition prompt comprising an additional foreground object;
based on a depth map of the background image, determining a cutout occlusion of the additional foreground object in the composite image; and
generating an additional composite image comprising the foreground object concept and the additional foreground object stitched together with the background image according to the cutout occlusion.

16. A non-transitory computer-readable medium comprising instructions that, when executed by at least one processor, cause the at least one processor to perform operations comprising:
generating, utilizing a background projector of a multi-modal large language model, a set of background tokens for a background image of a text prompt;
generating, utilizing a foreground projector of the multi-modal large language model, a set of foreground tokens for a foreground image of the text prompt; and
generating, utilizing the multi-modal large language model, a predicted image composition from the set of background tokens and the set of foreground tokens.

17. The non-transitory computer-readable medium of claim 16, wherein the operations further comprise:
generating, utilizing a depth estimation model, a depth map from the background image of the text prompt;
generating, utilizing a depth projector of the multi-modal large language model, a set of depth tokens from the depth map; and
generating the predicted image composition of the foreground image to insert within the background image at a predicted depth based on the set of depth tokens.

18. The non-transitory computer-readable medium of claim 16, wherein the operations further comprise:
generating, utilizing a text encoder of the multi-modal large language model, text tokens from the text prompt; and
generating the predicted image composition from the set of background tokens, the set of foreground tokens, and the text tokens, wherein the text tokens indicate user controls to guide a generation of the predicted image composition.

19. The non-transitory computer-readable medium of claim 16, wherein generating the predicted image composition comprises:
generating a plurality of bounding boxes for positions of the foreground image in the background image according to the text prompt and a depth map of the background image;
selecting a bounding box indicating a position of the foreground image in the background image; and
generating the predicted image composition from the selected bounding box indicating the position of the foreground image.

20. The non-transitory computer-readable medium of claim 16, wherein the operations further comprise:
stitching the foreground image with the background image according to the predicted image composition to generate a composite image;
providing the composite image to a user of a computing device; and
receiving an additional image composition prompt to modify the composite image.
